(19) United States
(12) Patent Application Publication
(10) Pub. No.: US 2004/0172271 A1
(43) Pub. Date: Sep. 2, 2004

(54) System and method for online dispute resolution and management

(75) Inventor: Randall E. Butler, Houston, TX (US)

Correspondence Address: FULBRIGHT & JAWORSKI, LLP, 1301 MCKINNEY, SUITE 5100, HOUSTON, TX, 77010-3095, US

(73) Assignee: Butler Online Mediation, L.P., Houston, TX

(21) Appl. No.: 10/733,500

(22) Filed: Dec. 11, 2003

Related U.S. Application Data
(63) Continuation-in-part of application No. 10/210,925, filed on Aug. 2, 2002.
(60) Provisional application No. 60/309,996, filed on Aug. 3, 2001.

(51) Int. Cl. G06F 17/60

(52) U.S. Cl. 705/1; 705/80

(57) ABSTRACT

A computer-implemented system and process for the purpose of dispute resolution and management. The invention provides a system and method particularly adapted for tracking and mediating disputes, such as multiparty lawsuits, including both simultaneous and asynchronous submission of offers and demands in the mediation/negotiation context thus eliminating many of the inefficiencies inherent in traditional mediation processes.

### BACKGROUND OF THE INVENTION

This application is a continuation-in-part of application Ser. No. 10/210,925, now pending, filed Aug. 02, 2002 and claims the benefit of the filing date of Provisional Application Serial No. 60/309,996 filed Aug. 03, 2001.

The present invention relates generally to a system and method of communicating information between two or more stations or client sites which are located remotely from one another. More particularly, the invention relates to a system and method of communicating information between one or more such stations for the purpose of providing computer-implemented dispute resolution and management. In one application, a system and a method are provided which are particularly adapted for use with or over a communications network including the Internet.

The present mode of dispute resolution, such as mediation of complex multiparty lawsuits, has been a frustrating experience for most lawyers and their clients. For example, the typical silicosis case involves one plaintiff's lawyer trying to settle with as many as thirty-five defendants, each one represented by a lawyer. In most cases, the plaintiff's lawyer prefers to negotiate individually with each defendant either in person, via written correspondence, telephonically or sometimes using e-mail. Some time prior to the mediation and often at the mediation, the plaintiff's lawyer will make an individual demand in writing or orally to each defendant. If made at the mediation, the demand is communicated through the mediator. The mediator is also expected to meet with the defendants as a group to hear their perspective on the case with particular reference to the work history of the plaintiff and his medical condition. Because the mediation generally takes up an entire day, the defendants usually want to bundle as many plaintiffs in one mediation as possible. Sometimes the claims of as many as fifteen individual claimants will be discussed and negotiated in a single day. In a traditional mediation the result is a very inefficient process.

If the mediator attempts to meet with each defendant to discuss the case on an individual basis for just five minutes, 1½-2 hours of the mediation can be consumed with just one round of meetings. The result is that a room full of lawyers are paid by their clients and insurance companies to attend a six to eight hour mediation with the expectation of having one-on-one time with the mediator totaling at most 15 minutes. Even then, only preliminary work is accomplished in the mediation. Very few cases get settled with a significant number of the defendants. Although inefficiencies such as these are associated with existing methods and systems for conducting dispute resolution, these inefficiencies have long been accepted by both the plaintiffs and defendants involved in such disputes.

### SUMMARY OF THE INVENTION

It is, therefore, one of multiple objectives of the invention to provide a computer-implemented system and process for the purpose of dispute resolution and management. More particularly, the invention provides such a system and method particularly adapted for tracking and mediating disputes, such as multiparty lawsuits, including both simultaneous and asynchronous submission of offers and demands in the mediation/negotiation context thus eliminating many of the inefficiencies inherent in traditional mediation processes.

The inventive system and method provides for the registration of disputes between various entities, such as individuals, estates, companies, and government agencies (referred to as disputants). These disputes are generally in the form of litigation between disputants, but may be in the form of other dispute types that have not yet entered into a formal legal process. Claim information is entered into the system for the disputant and disputant representative. A disputant, although usually represented by an attorney, may choose to represent itself. Often times, as in complex litigation, the dispute will include multiple participants. For example, in an asbestosis suit, a single plaintiff may bring a law suit against multiple defendants. Information related to each of the parties to the dispute and their representatives will be entered into the system to form a dispute registration. The dispute registration may include such information as the name of the claimant, the cause number (if the claim is in suit), the style of the case (if the claim is in suit), the name of the attorney for the claimant with associated contact information; and names of the defendants and their attorneys with associated contact information. The dispute registration is stored in a database with a unique identifier which is used to reference other information related to the dispute.

After registration of the dispute, each of the disputant representatives will be sent unique access identifier information. This information usually consists of a user-id and a password that may be used by the disputant representative to access the inventive system. However, other information and techniques used in the art may be utilized provided that secure access to the system is accomplished. The unique access identifier information may be sent to the disputant representative via e-mail, regular mail, or other secured transmission means. Each user of the inventive system is granted certain rights and permissions to access various screens and perform various processes depending on the classification of the user. Some of the users include the mediator, a registrar, attorneys representing disputants and disputant representatives.

Utilization and access to the inventive system is preferably through a web browser with a user interface that may access a central server through an interactive network, such as the Internet or an intranet. Alternatively, a non-web browser based application may be utilized. The central server receives and transmits communications and data from the server to the web browser client stations.

In one embodiment, particularly adapted for computer-implemented mediation and coordination and management of evaluative information concerning the dispute, disputant representatives, using a General Exchange interface, enter information responsive to prompted questions. The questions presented may be of a general nature or may be presented based on a dispute type. The answers to these questions aid the disputant representatives in the evaluation of the dispute. This general claim information data may be viewed by any disputant representative for the particular dispute.

Furthermore, a Private Exchange interface is made accessible only to the disputant representative for a claimant and the disputant representative for a defendant. In the Private Exchange, the attorney for that defendant may input case specific information relevant only to his/her defendant in relation to a particular dispute. The attorney for the claimant may input case specific information relevant to that particular claimant. Both the attorney for the claimant and the attorney for the defendant have read only access rights to the Private Exchange information provided by the opposing disputant representative. Unlike the General Exchange information which is publicly viewable by all of the disputant representatives for a particular dispute, the Private Exchange information is viewable only by the disputant representative that entered its client's information and the opposing, party's disputant representative.

The inventive system and method provides an interface wherein the disputant representatives for the parties to the dispute may make settlement offers and demands to a specific opposing party. Each of the parties to a negotiation will be informed by e-mail, electronic page, a screen tickler and/or notification that an offer/demand has been made and the amount of the offer or demand. The inventive system may determine when settlement has been achieved. One way this is accomplished is when an offer and demand are of equal values. In one embodiment, a time period is either agreed to by the parties who are in settlement negotiations, or is set by a mediator. Another settlement method is through the use of an aggregate offer where the first party may send a second party an aggregate offer made that totals total individual offers made by the members of the first party. During the time period the parties may continue to make offers and demands.

Another aspect of the inventive system is the generation of reports for the disputant representatives and reports to aid the mediator in evaluating negotiations and management of the system. Some of these reports for the mediator include: 1) registrations only partially inputted by the Registrar; 2) a current month and prior month summary for each registered defendant of total number of settlements, impasses, mediations in progress, and upcoming mediations, as well as the total aggregate dollar amounts settlements by each defendant; 3) a current month and prior month summary of mediation activity of any registered defendant with a specific registered claimant attorney including total number of settlements, impasses, mediations in progress, and upcoming mediations, as well as the total aggregate dollar amounts settlements; 4) current month and prior month mediation progress report on a particular claimant (represented by a particular claimant attorney) with any defendant, including whether case reaches an impasse, settlement amount if settled, and last offer and demand; 5) a current month and prior month summary of mediation activity of all registered claimant attorneys including total number of settlements, impasses, mediations in progress, and upcoming mediations, as well as the total aggregate dollar amounts settlements; 6) a current month and prior month summary of mediation activity of any one registered claimant attorney with all defendants who have mediations online with that claimant attorney, including total number of settlements, impasses, mediations in progress, and upcoming mediations, as well as the total aggregate dollar amounts settlements; 7) a current month and prior month summary of mediation activity of any one registered claimant attorney with respect to each of his clients who have mediations online with any one defendant, including total number of settlements, impasses, mediations in progress, and upcoming mediations, as well as the total aggregate dollar amounts settlements; 8) a current month and prior month summary of mediation activity of any one registered claimant attorney with respect to each of his clients who have mediations online, including whether case reaches an impasse, settlement amount if settled, and last offer and demand; 9) summary of cases registered but not activated for mediation; 10) a summary of cases registered and activated but for which fees have not been paid by claimant attorneys or defendants, including the amount if any paid, the amount of fee to be paid, the date any partial payment was received, the name of party who owes, the cause number, name of claimant, and whether an email reminder has been sent; 11) summary of cases registered with fees paid, but not activated, including a function for activating the mediation pairing on that screen; 12) summary of all unsettled mediation pairings, including both attorneys' names, and auto email function for contacting the attorneys to encourage further negotiation or reactivation of the mediation; 13) list of all attorneys registered in the system including email and telephone numbers, and auto email function and edit function; 14) list of all defendants registered in the system including edit and add new defendant functions; 15) list of defense attorney—defendant associations in the system with the ability to change those associations; 16) summary of all settled cases on the system.

Some of these reports for the registrar include: 1) list of all attorneys registered in the system including email and telephone numbers, and auto email function and edit function; 2) list of all defendants registered in the system including edit and add new defendant functions; 3) list of defense attorney—defendant associations in the system with the ability to change those associations; 4) registrations only partially inputted by the Registrar; and 5) list of cases registered in the current month, with the ability to access the individual case registration from the screen.

Some these reports for the attorney users and disputant representatives include: 1) a summary of claimant/defendant mediation pairings in progress involving clients of the attorney user, including the time left to mediate the case online, the amount of the latest offer or demand to settle that pairing, an indication as to whose turn it is to make an offer or demand, whether group demands or offers have been made involving that claimant/defendant, a input box for making another offer or demand to settle that mediation pairing, and the ability to access the General Exchange and Private exchange for that pairing directly from that screen; 2) Upcoming Mediations—a list of mediations with start dates still in the future; 3) a summary of concluded mediation pairings, including whether the mediation settled, the settlement amount, and the last offer and demand if the case did not settle; 4) a summary of the mediation activity for all claimants represented by a particular claimant attorney (accessible only by the particular claimant attorney representing those claimants); 5) a summary of the mediation activity of all defendants represented by a particular defendant attorney and accessible only by that defendant attorney; 6) a summary of the mediation activity for all claimants with a specific defendant represented by a particular defendant attorney and accessible only by that defendant attorney, including settlement amounts, and if an impasse is reached, last offer and demand; 7) a summary of mediations involving a particular claimant with all defendants; and, 8) a summary of all Group mediations involving clients of a particular attorney, including the results of mediation.

Another feature and advantage offered by the invention is a system and method of accumulating, organizing, viewing, and sharing evaluative information concerning a claimant and the dispute. This information is collected and organized through the use of preset fields with a combination of open data inputs and preset limited optional responses. The system is unique in that it captures the essential factual information necessary to dispute management and evaluation for purposes of mediation and negotiation.

In one embodiment, attorneys for disputants will be able to use the inventive system as cost-effective and more cost-efficient method of dispute reporting to their respective clients and client representatives. Currently, most attorneys for disputants must gather evaluative information and transmit it by email or correspondence. The information transmitted is either collected in a paper based filing system or manually entered in a local database. The inventive system provides a remotely accessible database of key evaluative information.

Another feature and advantage of the inventive system is the provision of criteria categories for evaluation of disputes in a systematic fashion. Users of the system will not merely be supplying information through the system on an ad hoc basis but will be directed as to what information to provide that will aid opposing parties in the proper evaluation of the dispute thus facilitating a more just outcome. An important feature of the inventive system is it ability to inform and direct the participation of users in order to more efficiently and effectively facilitate resolution of disputes.

As yet another feature and advantage offered by the invention, a system and method of online dispute resolution is provided that greatly benefits the dispute participant. The inventive system and method provides improved efficiency and flexibility, and is easy to use. In many applications, the dispute participants save considerable time and expense. For example, a dispute resolution process, such as mediation, is not limited to a specific geographic location. Dispute participants may be geographically located hundreds or thousand miles apart. The dispute participants may remotely access the inventive dispute resolution system thereby saving on travel time and related expenses. Furthermore, the inventive system and process avoids the expense of a disputant representative, such as an attorney, spending a full day of non-productive negotiation. Instead, attorney time would be focused to that time of access and use of the system. Moreover, the system provides automation of those tasks typically required of the mediator, such as acting as a messenger for the settlement offers made by each of the parties.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a representation of a computer display depicting a screen for searching existing registrations;

FIG. 1A is a representation of a computer display showing search results for registrations;

FIG. 1B is a representation of a computer display depicting registration summary information;

FIG. 2 is a representation of a computer display depicting a screen for adding a registration;

FIG. 3 is a representation of a computer display depicting a screen for adding claimants to a registration and navigation tools for accessing screens to edit claimant information or add claimants during the registration process;

FIG. 4 is a representation of a computer display depicting a screen for adding a claimant to a registration and activating the mediation pairing on the system for access and participation by the attorney for the claimant;

FIG. 4A is a representation of a computer display depicting a screen showing an added claimant;

FIG. 4B is a representation of a computer display depicting a screen for adding defendants;

FIG. 4C is a representation of a computer display depicting a screen for editing defendants;

FIG. 4D is a representation of a computer display depicting an Add New Claim—Defendant Info screen;

FIG. 4E is a representation of a computer display depicting an Add New Claim—Defendant Info screen;

FIG. 4F is a representation of a computer display depicting an Edit Defendants screen;

FIG. 5 is a representation of a computer display depicting a screen showing a listing of defendants added to a registration;

FIG. 6 is a representation of a computer display depicting a screen showing a listing of attorneys set up in the system;

FIG. 6A is a representation of a computer display depicting a screen for adding an attorney to the system;

FIG. 6B is a representation of a computer display depicting a screen for editing attorney and defendant ties;

FIG. 6C is a representation of a computer display depicting a screen for editing attorney and defendant ties;

FIG. 7 is a representation of a computer display showing a list of full registrations;

FIG. 8 is a representation of a computer display showing a list of partial registrations;

FIG. 9 is a flow chart summarizing an exemplary functions and navigation flow of the inventive system and method;

FIG. 10 is a representation of a computer display showing a list of Mediations in Progress;

FIG. 10A is a representation of a computer display showing a list of Mediations in Progress;

FIG. 10B is a representation of a computer display showing a list of Mediations in Progress;

FIG. 11 is a representation of a computer display showing a General Exchange general case information;

FIG. 12 is a representation of a computer display showing a General Exchange screen for inputting general case information;

FIG. 12A is a representation of a computer display showing a General Exchange/General Case Info—Substance Abuse;

FIG. 12B is a representation of a computer display showing a screen for editing or entering information concerning General Exchange/General Case Info —Substance Abuse;

FIG. 12C is a representation of a computer display showing a General Exchange/General Case Info—Special Damages;

FIG. 12D is a representation of a computer display showing a screen for editing or entering information concerning General Exchange/General Case Info —Special Damages;

FIG. 12E is a representation of a computer display showing a General Exchange/General Case Info—Other Lawsuits and the Statute of Limitations;

FIG. 12F is a representation of a computer display showing a screen for editing or entering information concerning General Exchange/General Case Info —Other Lawsuits and the Statute of Limitations;

FIG. 12G is a representation of a computer display showing a General Exchange/General Case Info—Military service of the claimant;

FIG. 12H is a representation of a computer display showing a screen for editing or entering information concerning General Exchange/General Case Info — Military service of the claimant;

FIG. 12I is a representation of a computer display showing a General Exchange/General Case Info—smoking history of the claimant;

FIG. 12J is a representation of a computer display showing a screen for editing or entering information concerning General Exchange/General Case Info—smoking history of the claimant;

FIG. 13 is a representation of a computer display showing a General Exchange for employment information;

FIG. 13A is a representation of a computer display showing the method for inputting name of employer, time worked there, and job duties;

FIG. 14 is a representation of a computer display showing a General Exchange for medical information—radiographic studies;

FIG. 14A is a representation of a computer display showing a screen for editing or inputting General Exchange/medical information—radiographic studies;

FIG. 15 is a representation of a computer display showing a General Exchange/medical information—chest x-rays;

FIG. 15A is a representation of a computer display showing a screen for editing or inputting General Exchange/medical information—chest x-rays;

FIG. 15B is a representation of a computer display showing a General Exchange/medical information—lung CT scans;

FIG. 15C is a representation of a computer display showing a screen for editing or inputting General Exchange/medical information—lung CT scans;

FIG. 15D is a representation of a computer display showing a General Exchange/medical information—lung MRI scans;

FIG. 15E is a representation of a computer display showing a screen for editing or inputting General Exchange/medical information—lung MRI scans;

FIG. 15F is a representation of a computer display showing a General Exchange/medical information—PFT (pulmonary function studies);

FIG. 15G is a representation of a computer display showing a screen for editing or inputting General Exchange/medical information—PFT (pulmonary function studies);

FIG. 15H is a representation of a computer display showing a General Exchange/medical information—physician diagnosis;

FIG. 15I is a representation of a computer display showing a screen for editing or inputting General Exchange/medical information—physician diagnosis;

FIG. 15J is a representation of a computer display showing a General Exchange/medical information—Pathology for a claimant;

FIG. 15K is a representation of a computer display showing a screen for editing or inputting General Exchange/medical information—Pathology;

FIG. 15L is a representation of a computer display showing a General Exchange/medical information—Other illnesses and injuries;

FIG. 15M is a representation of a computer display showing a screen for editing or inputting General Exchange/medical information—Other illnesses and injuries;

FIG. 15N is a representation of a computer display showing a General Exchange/equipment information;

FIG. 15O is a representation of a computer display showing a screen for editing or inputting General Exchange/equipment information;

FIG. 16 is a representation of a computer display showing a General Exchange comparison of data;

FIG. 17 is a representation of a computer display showing a variance of medical information;

FIG. 18 is a representation of a computer display showing a Private Exchange screen;

FIG. 19A is a representation of a computer display showing a screen used for inputting information by the Claimant Attorney on the Private Exchange screen concerning product usage by the claimant specific to the Defendant;

FIG. 19B is a representation of a computer display showing a screen used for inputting information by the Defendant Attorney on the Private Exchange screen concerning product non-usage by the claimant of specific products of the Defendant;

FIG. 20 is a representation of a computer display showing a Private Exchange with a settled dispute;

FIG. 21 is a representation of a computer display showing a Private Exchange with information concerning the status of the mediation as expired;

FIG. 22 is a representation of a computer display showing a list of Groups;

FIG. 23 is a representation of a computer display showing information for a single Group;

FIG. 24 is a representation of a computer display for editing a Group;

FIG. 25 is a representation of a computer display showing information for a single Group;

FIG. 26 is a representation of a computer display showing group information;

FIG. 27 is a representation of a computer display showing a list of upcoming Mediations;

FIG. 28 is a representation of a computer display showing a list of concluded Mediations by defendant;

FIG. 29 is a representation of a computer display showing a list of concluded Mediations for a defendant;

FIG. 30 is a representation of a computer display showing a list of concluded Mediations by claimant;

FIG. 31 is a representation of a computer display showing a list of concluded Mediations for a claimant;

FIG. 32 is a representation of a computer display depicting a screen for searching existing claimants;

FIG. 33 is a representation of a computer display showing search results for claimants;

FIG. 34 is a representation of a computer display showing a list of fully registered and activated, defendant report;

FIG. 34A is a representation of a computer display showing a list of fully registered and activated, defendant detail report;

FIG. 35 is a representation of a computer display showing a list of fully registered and activated, defendant/claimant mediations report;

FIG. 36 is a representation of a computer display showing a list of unsettled pairings;

FIG. 37 is a representation of a computer display depicting a screen for adding a Registrar;

FIG. 38 is a representation of a computer display depicting the note making function in the direct negotiation of single pairings;

FIG. 39 is a simplified system configuration diagram according to the present invention;

FIG. 40 is a representation of a computer display depicting the Private Exchange and the ability of the Mediator to direct a note to a particular attorney but not the other;

FIG. 41 is a representation of a computer display depicting a representation of a computer display for submitting a non-suit request;

FIG. 41A is a representation of a computer display depicting a representation of computer display of the Private Exchange reflecting the prior submission of a non-suit request by the representative of the defendant;

FIG. 42 is a representation of a computer display depicting a screen utilized by the Mediator to obtain reports of all settlements for a particular user;

FIG. 43 is a representation of a computer display showing Advanced Mediations in Progress;

FIGS. 44 A-B are representations of computer displays for illustrating displaying and uploading images or digital documents associated with a claimant;

FIGS. 45 A-B are representations of computer displays showing Premediation demand screens;

FIG. 46 is a representation of a computer display showing Concluded Mediations for a Defendant;

FIG. 47 is a representation of a computer display showing Group Demand/Offers; and

FIGS. 48 A-B are representation of computer displays showing Registration Summary.

### DETAILED DESCRIPTION

Accordingly, the present invention is not intended to be limited to the systems, structures, methods, and processes specifically described and illustrated herein. For example, the following description is particularly directed to a computer-implemented dispute resolution system and method over an interactive communications network or computer network such as the Internet, but is not limited to such a communications network.

### Computer System Environment of the Present Invention

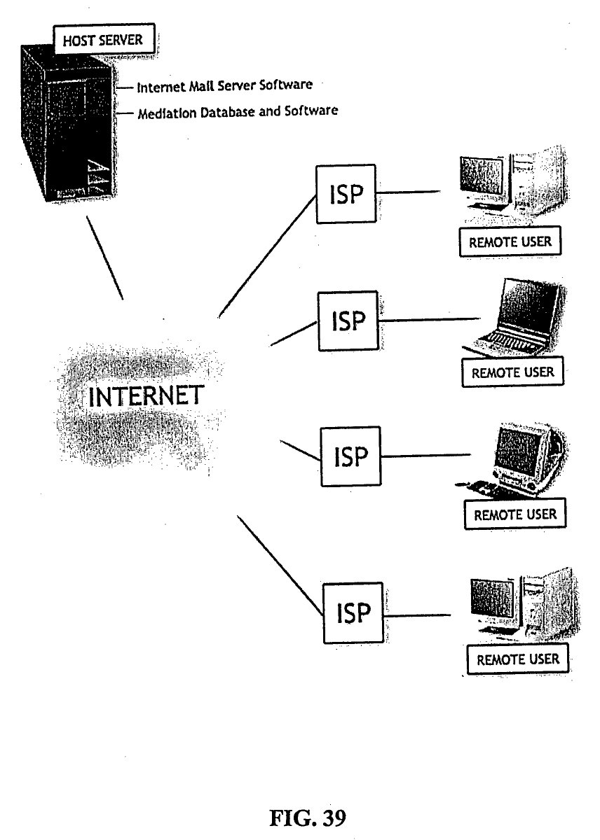

With reference now to FIG. 39, portions of the present dispute resolution system are comprised of computer-readable and computer-executable instructions which reside, for example, in computer-usable media of a computer system. FIG. 39 illustrates an exemplary computer system used as a part of a dispute resolution system in accordance with the present invention. It is appreciated that the system of FIG. 39 is exemplary only and that the present invention can operate within a number of different computer systems including general purpose computers systems, embedded computer systems, and stand alone computer systems specially adapted for automatic system error analysis. A computer-usable medium may include any kind of computer memory such as floppy disks, conventional hard disks, CD-ROMS, Flash ROMS, nonvolatile ROM, and RAM.

### Database Environment of the Present Invention

A database management system, commonly referred to herein as a database, is used in conjunction with the present invention for the storage and retrieval of various information captured by system interfaces, such as a user interface, or information that is manipulated by program logic. Preferably, the database is of the relationship type, although other hierarchical, n-tier or other database capable of storing and retrieving the information used by the system may be utilized.

A relational type of database is commonly made up of tables containing records. The fields may be of various data types and lengths. A record usually consists of one or more fields. Another name for a record is a row. A collection of records are referred to as sets. Tables often have fields that serve as key values that make a record unique in a table. Also, two or more tables may be joined together through the use of an intersection table or through programmatic code that will join table together based on field values.

The database used with the inventive system may reside on a single database server, or may be distributed on multiple database servers. For example, a database may be configured in such a way that the computer files that contain the data of the database, may reside on separate computer servers. Also, database data may reside logically in memory such as RAM.

Also, the database of the inventive system may be accessed from user interfaces of the present invention, either directly or indirectly (for example, through an intermediary application program), or a combination thereof. User interfaces may contain programming code that allows the user interface to directly access the database management system. Alternatively, the programming logic may interact through one or more intermediary programs which receives storage and retrieval requests. The intermediary program may handle the direct interaction to the database.

The present invention preferably includes a database with a database structure configured for the collection of dispute data and management of dispute information. In one embodiment, the database includes tables containing dispute registration data, such as the data discussed in the section below titled Registering a Dispute. A particular instance of a dispute is given a unique dispute identifier. This identifier is used to relate various data related to a dispute. Other structures of the present invention, include a structure for general exchange information, and private exchange information. The general exchange information and private exchange information may be related to the disputants for which the information relates and also the particular dispute. Additionally, other data structures may include administrative tables, and the like.

### Further Detail Description of the Present Invention

Registering a Dispute

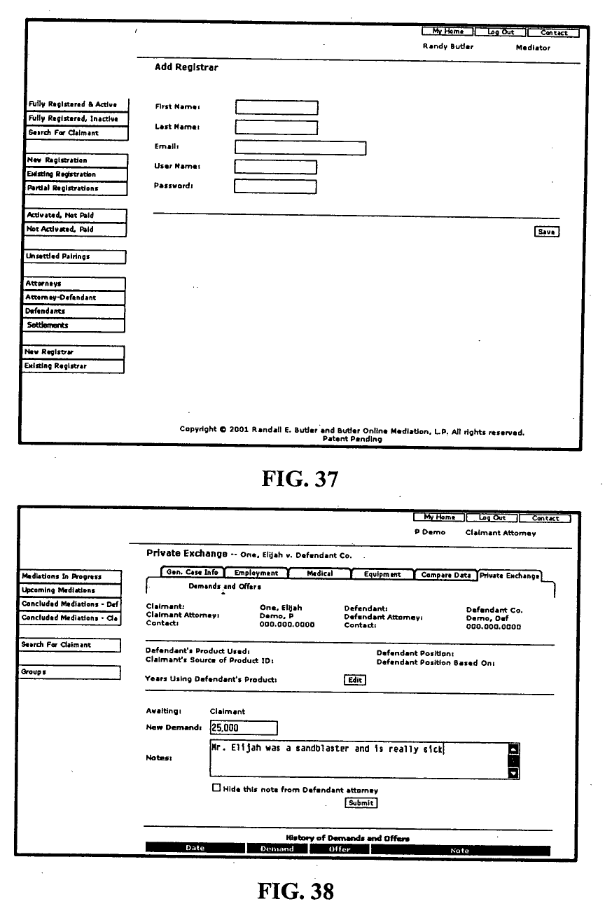

In one embodiment, a Mediator or an authorized Registrar registers the dispute. FIG. 37 is a representation of a computer display depicting a screen for adding a Registrar. Additionally, the Mediator may delete the Registrar from the system. In one embodiment, the Mediator may grant the Registrar certain permissions to carry out particular operations and view only certain screens and data. This allows the Mediator to grant certain tasks to another person while still maintaining control of other screens and data privy only to the Mediator.

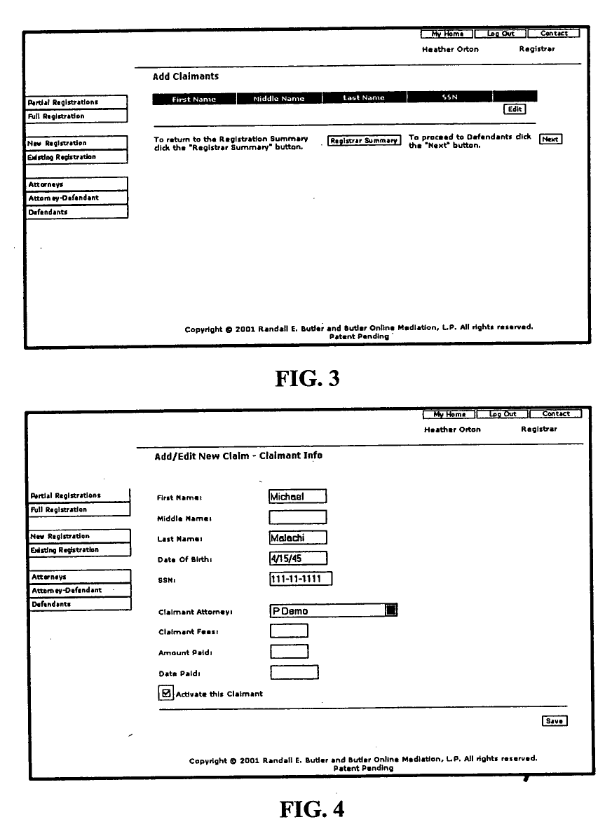

Referring to FIG. 2, the inventive system prompts the Mediator or Registrar via a user interface, “Add Registration,” for specific information to register a dispute. The screen is accessed by clicking on the tab on the left side of the screen labeled “New Registration.” In one embodiment, the data requested is the following:

1. state;

2. county,

3. the cause number (if the claim is in suit);

4. the court number (if the claim is in suit);

5. the number of claimants;

6. the number of defendants; and

7. the type of the case.

After the required information is entered concerning the case, the Registrar clicks on the “Save” button and the system then presents to begin the addition of claimants for the particular dispute (see FIG. 3).

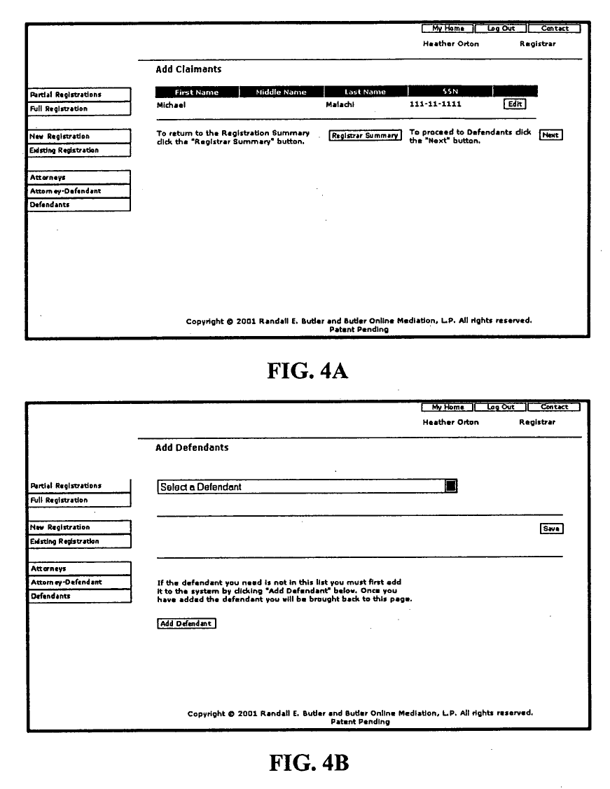

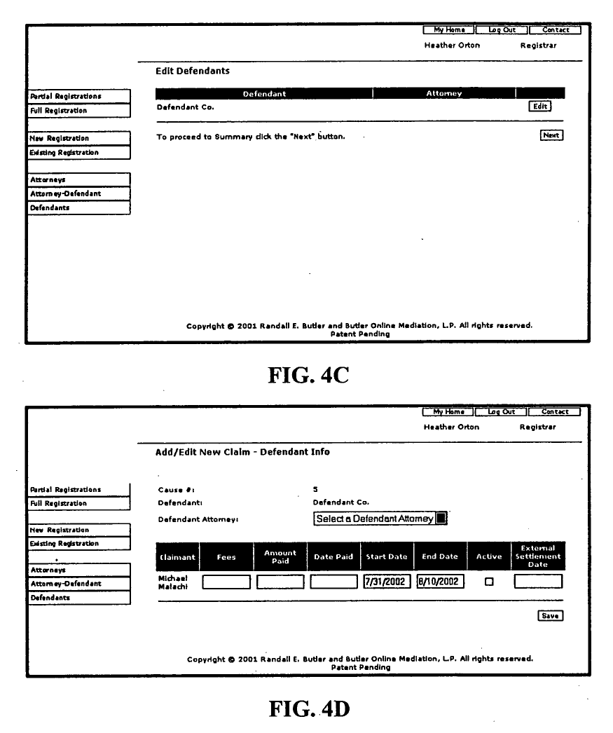

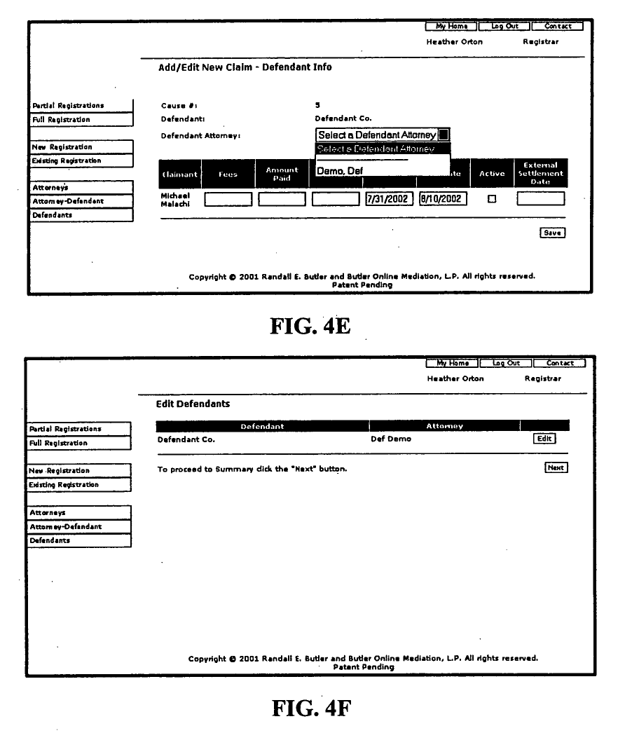

FIG. 3 is a representation of a computer display depicting the next screen in the process of registering a case for mediation online. This screen automatically provides rows for inputting the number of claimants in the case, based on the number of claimants input on the screen in FIG. 2, showing claimants that have been added to a registration. Initially, this screen does not depict any claimants for a new registration. Clicking the “Edit” button one each row provided will present a screen (as in FIG. 4) with blank data fields allowing the Registrar to add a new claimant. Clicking on the “Edit” button next to the record for an already added claimant will present a screen (FIG. 4) with the selected claimant's information. The edit function allows the Registrar to make changes with reference to the claimant.

FIG. 4 is a representation of a computer display depicting a screen for adding a claimant to a registration. The “Add Claimants” screen allows entry of information concerning the claimant and claimant attorney. Additionally, activation of the claimant may be performed on the screen by selecting the “Activate this Claimant” check box. Activation means that the Claimant's Attorney will be able to access, view and input information on the General Exchange and Private Exchanges for that claimant, and enter settlement demands. Clicking the “Save” button saves the claimant information to the database and the system returns back to the screen depicted in FIG. 3 but which now lists the claimants that have been added to the dispute. (See FIG. 4A) Once the claimants have been added, the Registrar then clicks on the “Next” button in FIG.4A. The system then displays the “Add Defendants” screen (FIG. 4B).

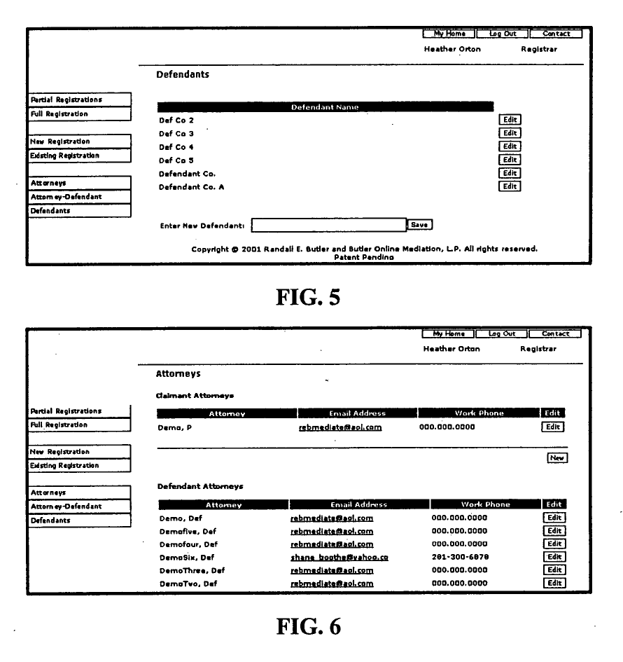

The Add Defendants screen (FIG. 4B) provides one box for each defendant in the case, based on the number of defendants entered on the initial registration screen, FIG. 2. Inside each box is a pull down menu with the names of all defendants registered in the system. If the defendant to be registered in the particular case is not on the drop down menu, the Registrar may click on the Add Defendant button, which produces the Defendants screen, FIG. 5. Using the box at the bottom of the screen in FIG. 5, the new Defendant can be added to the system. Upon doing so, the Registrar is returned to the Add Defendants screen, FIG. 4B. The Registrar selects a defendant in each box and then clicks on the “Save” button and is then taken to the Edit Defendants screen (FIG.4C).

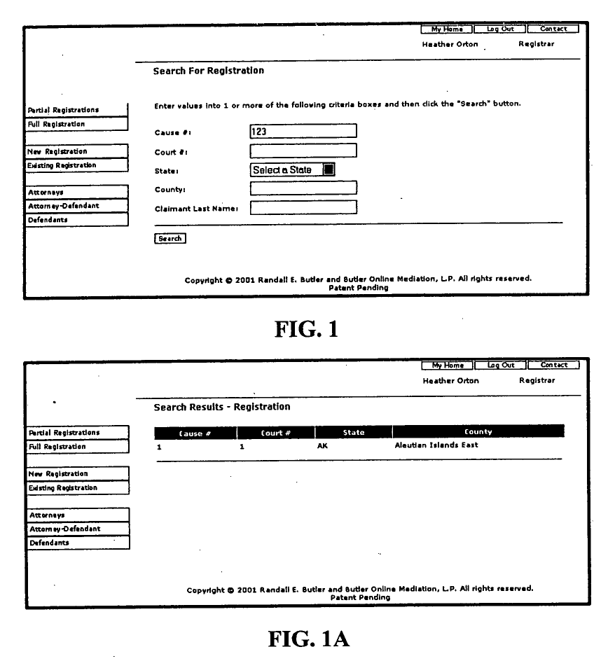

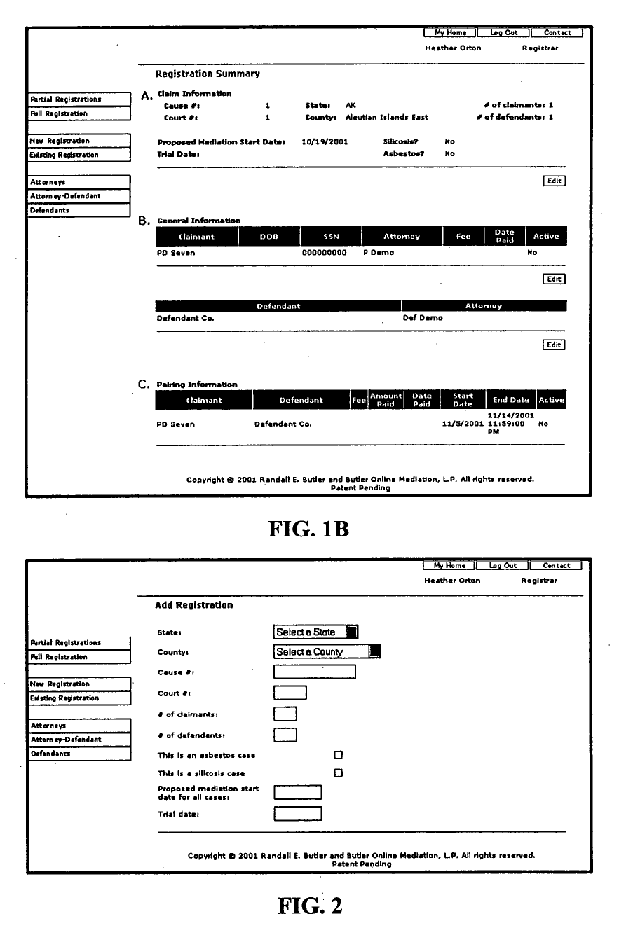

On the Edit Defendants screen (FIG. 4C) one row of information to be completed will appear for each Defendant selected on the Add Defendants screen (FIG. 4B) which is also consistent with the number of defendants originally entered on FIG.2. The Registrar clicks on the Edit button which takes him to the Add New Claim-Defendant Info screen (FIG. 4D.) It is here that the Registrar selects the name of the Defendant Attorney representing the particular defendant for that screen. This is done by selecting the name of a lawyer from the drop down menu on the screen, as in FIG.4E. Only the names of lawyers previously registered and associated in the system with that defendant appear in the box on the screen for that particular defendant. The Registrar then supplies the additional information requested concerning payment and activates the mediation pairing for that defendant and defendant attorney. Once activated the defendant attorney will be able to access the General Exchange for that claimant, the Private Exchange for that claimant with his or her defendant and to negotiate that mediation pairing. Upon entering the information requested on FIG. 4E, the Registrar then clicks on the “Save” button which produces the Edit Defendant screen, but with the name of the defendant attorney now filled in, as in FIG. 4F. After the Registrar has edited each of the Defendants (each row provided) she then clicks on “Next” which takes her to the “Registration Summary” screen, and FIG. 1B.

FIG. 5 is a representation of a computer display depicting a screen showing a listing of all defendants who have at any time been registered in the system. This screen is referred to as the “Defendants” screen. By clicking on the “Edit” button, the registrar can edit the name of a particular defendant. The Registrar can add a defendant to the system by typing in the name of a defendant and clicking on the “Save”. The system will add the defendant's name to the database.

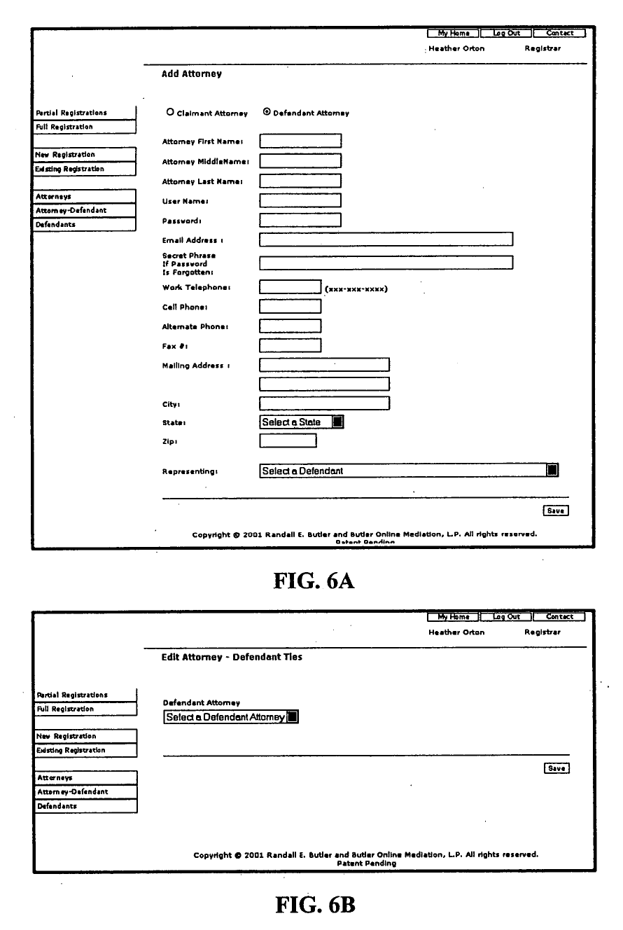

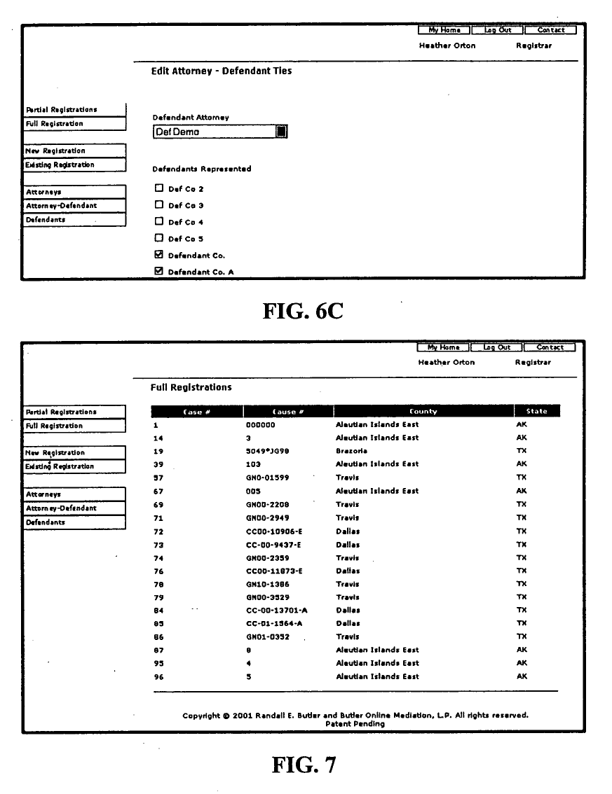

FIG. 6 is a representation of a computer display depicting a screen showing a listing of all of the attorneys set up in the system. The Registrar may access the “Attorneys” screen by clicking on the “Attorneys Tab” to the left of the screen. To edit an attorney record, the “Edit” button next to the name of the attorney is selected. Selecting the “Edit” button will then display a screen (similar to FIG. 6a) where the particular detail information regarding the attorney may be edited. The Registrar may add an attorney to the system by clicking on the “New” button (FIG. 6). The system in response to the selection of the “New” button displays a user interface where the Registrar may input information into the system regarding the new attorney (see FIG. 6A).

FIG. 6A is a representation of a computer display depicting a screen for adding an attorney to the system. The Registrar enters the information requested. The Registrar selects a disputant in the drop-down list box for the “Representing” field. If the attorney is designated as a defendant attorney, the “Representing” drop-down list box will display defendants who have been registered in the system. If the attorney is designated as a claimant attorney, the “Representing” drop-down list box does not appear. Claimants are associated with claimant attorneys at the registration of their cases. The attorney associated with the particular disputant will only be able to access pairings involving the disputant associated with that attorney in the system.

FIG. 6B and 6C are a representation of computer displays depicting screens for editing defendant attorney and defendant ties. These screens allow the Registrar to edit the attorney-defendant relationships. The Registrar clicks on the “Attorney-Defendant” tab to the left, which displays the screen in FIG. 6B. A drop-down list box provides a list of the names of the attorneys registered in the system. Upon selection of one of the names, the screen as depicted in FIG. 6C is displayed. The Registrar may associate or disassociate the attorney with a particular defendant. Checking the box next to the name of a particular defendant will associate the attorney with that defendant. Conversely, by unchecking a box, the Registrar may remove an association between that attorney and the particular defendant.

In alternative embodiments, the inventive system may be configured to allow disputant representative to create a registration for a dispute.

Providing Permissions and System Access

In one embodiment, the system will generate user-ids and passwords for those disputant representatives who have been registered as part of a dispute registration. Alternatively, the mediator user and/or registrar user may assign the user-ids and passwords. The user-id and password will allow a disputant representative for a particular dispute to access the General and Private Exchange functionality wherein the disputant representative may provide information related to the particular dispute. Preferably, the user-id and password are securely distributed to the registered dispute participants. Additionally, the system may be configured such that access and use of the inventive system is allowed after payment of fee or other compensation.

Disputant Representative Default Screen

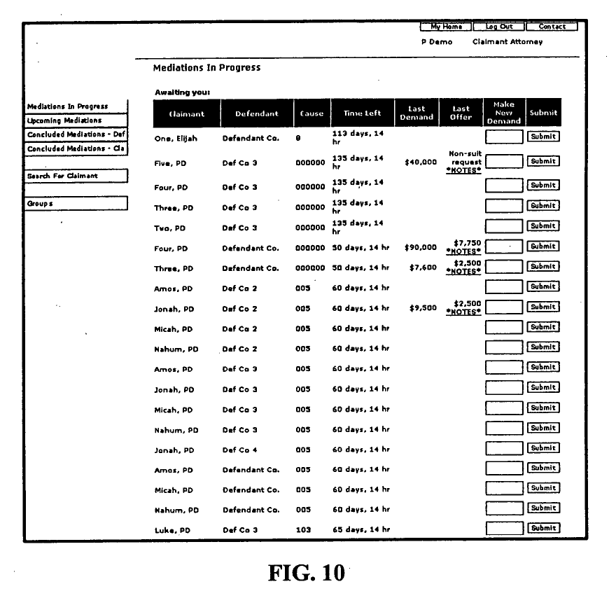

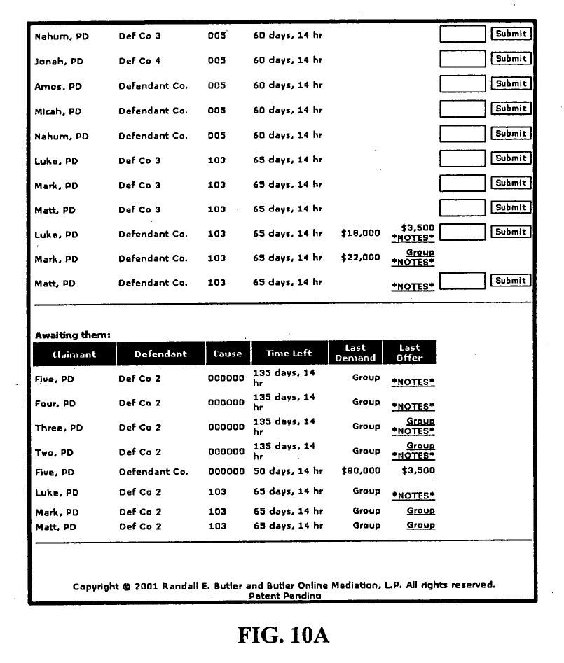

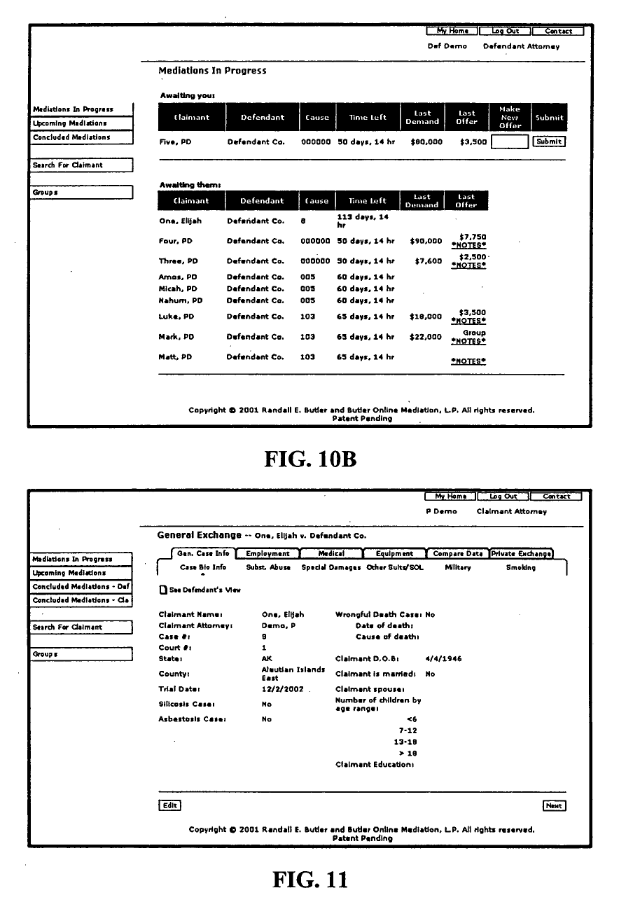

FIGS. 10, 10A and 10B are representations of computer displays showing a list of Mediations in Progress. In one embodiment, the system may be configured to display “Mediations in Progress” as the disputant representative's default screen. Mediation pairings appear on this screen on the start date for the particular mediation. “Time Left” is a count down to the “End Date” for a particular mediation. If the mediation has not settled by the “End Date,” the pairing deactivates and the disputant representative may no longer change or add information into the system regarding the particular mediation. In other words, the pairing becomes view only.

Mediation pairings appearing under the heading “Awaiting You” are pairings in which the opposing attorney has entered an offer/demand. This prompts the attorney that it is her turn to respond to offers/demands when cases appear under this heading. When the attorney user makes an offer/demand on a mediation pairing, the mediation pairing moves to the space under the “Awaiting Them” heading (see FIG. 10A). In this exemplary, the screen depicts a default home screen for a claimant's attorney. When the claimant's attorney makes a demand on a pairing, not only does the pairing move to his “Awaiting Them” section, it also moves to the “Awaiting You” section of the opposing attorney's screen (the attorney representing the defendant shown on the row as involved in that pairing) (see FIG. 10B). In response to clicking on the name of the claimant, the general exchange and private exchange for that claimant will be presented. An offer/demand can be made in the Private Exchange.

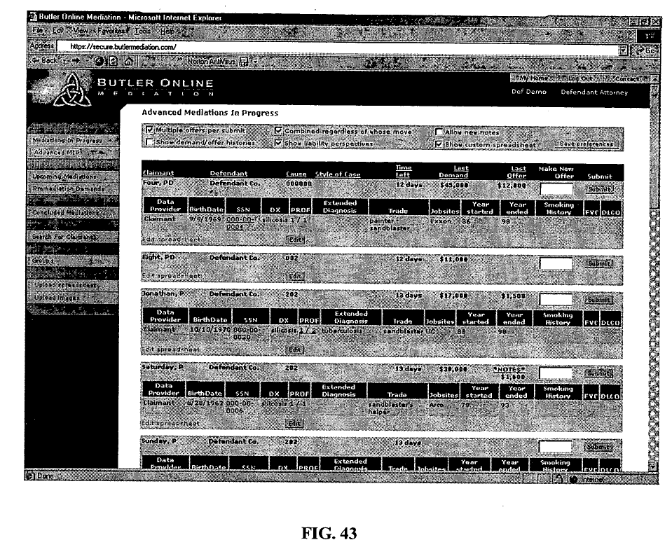

Referring now to FIG. 43, a representative screen of Advanced Mediations in Progress is shown. The user may utilize the Advanced Meditations in Progress screen to display multiple features of the claims resolution system on one scrollable screen. The check boxes at the top of the screen allow for display of various information. These selections may be saved as preferences so that one the Advanced Mediations in Progress screen is accessed, the selections of the various information to be displayed will be shown. For example, the selection of “Show demand/offer histories” will display the offer/demand histories. Selection of the “Allow new notes” checkbox will allow a section to of the screen to display an entry area for the addition of new notes.

Exchanging General Dispute Information

The inventive system and method provides an interface through which a disputant representative may disclose information that will be made publicly viewable to all disputant representatives to a particular dispute. This interface is referred to as the General Exchange. FIG. 11 depicts a representation of a computer display wherein a disputant representative for a particular dispute may view and/or enter General Exchange data. The inventive system will make this General Exchange data publicly accessible to all disputant representatives for a particular dispute. In one embodiment, the system presents to the disputant representative, a set of pre-defined questions with a pre-defined set of answers or a pre-defined range of acceptable values. The system may present alternative questions and answers depending on the type of the dispute. In other words, the system may be configured such that the questions presented to the disputant representatives are tailored to the type of dispute at hand. The disputant representative enters appropriate responses to the presented questions. The answers to the questions are then saved to a database with a relationship to the particular dispute registration. In one embodiment, a General Exchange interface consists of five navigable tabs: General Case Info, Employment, Medical and Equipment. General Case Info includes sub-tabs for Biographical Information about the claimant, history of any of substance abuse, military service record, special damages including lost income and wage earning capacity, and medical expenses, smoking history, and information concerning social security disability, if any. Defendant and claimant attorneys fill out their respective General Exchange submission screens. The General Exchange submission screens are available to all Defendants.

In other types of disputes, the General Exchange Submission screens may include Legal Issues, Liability, Medical Causation, Identification of Testifying Expert Witnesses, and the subject matter of their anticipated testimony, and other evaluation criteria specific to the type of case. In addition, General Exchange screens may include the more generic screens mentioned above, such as Personal Information, Education, and Special Damages.

Only the claimant's, attorney modifies claimants General Exchange screens and no history is maintained. Any defendant attorney representing a defendant in a mediation may modify the defendant's General Exchange screens in connection with a claimant in that mediation.

The information entered into the system in the General Exchange is considered public to those disputant representatives associated with the same dispute. Generally, the requested information will allow a party to the suit to evaluate the case and make reasoned offers and/or demands. For example, in a silicosis case, the following questions may be presented to the plaintiff's attorney:

Number of years of exposure?

Manner in which the plaintiff was exposed?

The type of dust mask, respirator, air fed respirator, air fed hood or non-air fed hood worn during exposures?

Age of plaintiff?

Current physical condition of plaintiff?

Pertinent testing and medical data available on the plaintiff?

Also, for specific defendants, counsel for plaintiff has the option of providing product identification sources. Likewise, lead counsel for defendant will also provide similar data, including IME results and data from treating physicians.

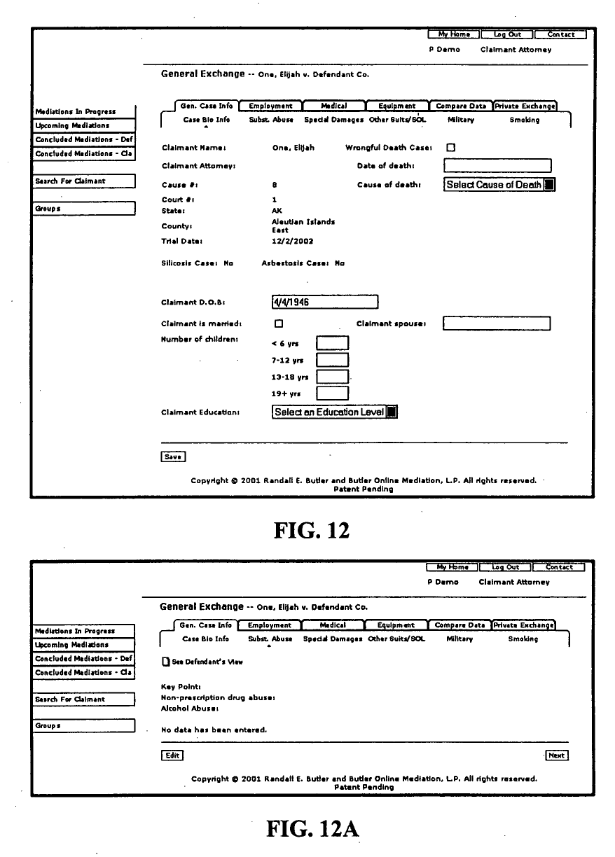

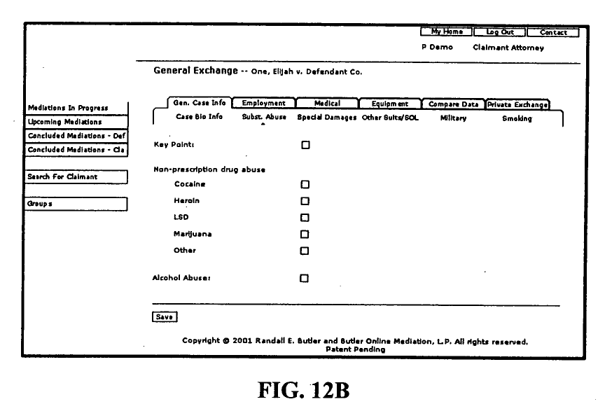

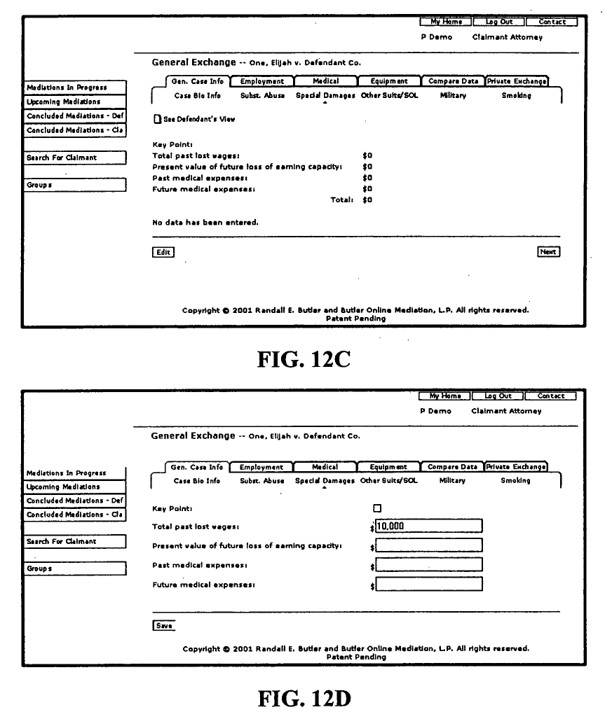

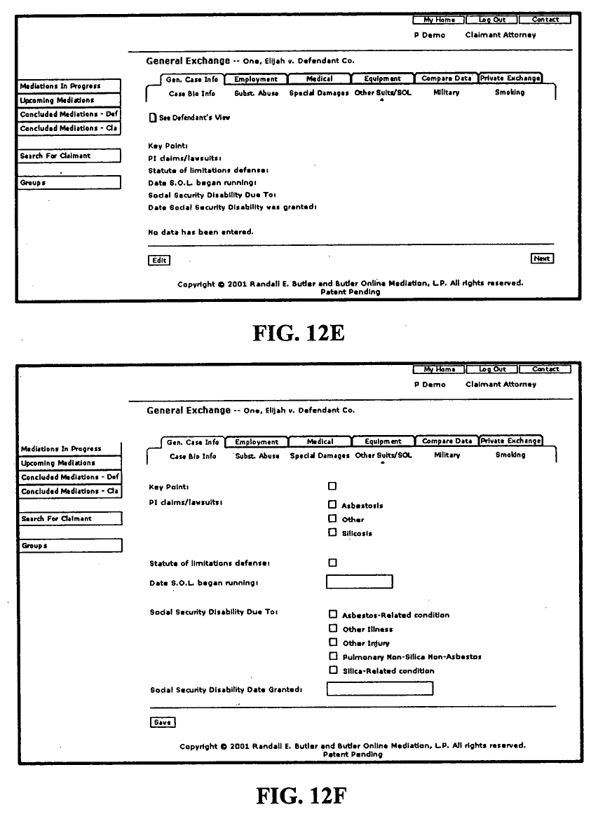

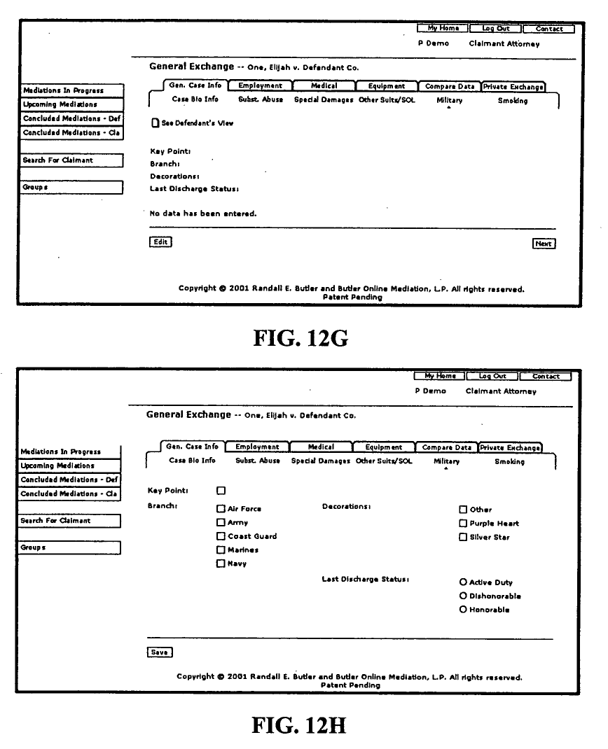

In response to receiving a click on the “Edit” button of the screen as shown in FIG. 11, the system displays the screen as shown in FIG. 12 with some of the data fields made editable to the user. The disputant representative may enter data or make changes to data in this particular screen. The disputant representative completes the requested information as prompted on the screen. In response to receiving a click on the “Save” button, the system saves the data to the database and returns the user to FIG. 11. This process is completed on each of the screens for which there is a tab or sub-tab.

FIG. 12A is a representation of a computer display showing a General Exchange/General Case Info—Substance Abuse. Any information entered by the user concerning any history of substance abuse by the Claimant will be displayed on this screen. To edit or add information concerning substance abuse the user clicks on the “Edit” button, which produces the screen as in FIG. 12B.

FIG. 12B is a representation of a computer display showing a screen for editing or entering information concerning General Exchange/General Case Info — Substance Abuse. The user enters the information, clicks on “Save” and is returned to the screen in FIG. 12A, which now displays the newly entered information or reflects the editing just done.

FIG. 12C is a representation of a computer display showing a General Exchange/General Case Info—Special Damages. Any information entered by the user concerning Past Medical Expense, Future Medical Expense, Lost Wages and Loss of Wage Earning Capacity of the Claimant will be displayed on this screen. To edit or add information concerning special damages, the user clicks on the “Edit” button, which produces the screen as in FIG. 12D.

FIG. 12D is a representation of a computer display showing a screen for editing or entering information concerning General Exchange/General Case Info — Special Damages. The user enters the information, clicks on “Save” and is returned to the screen in FIG. 12C, which now displays the newly entered information or reflects the editing just done.

FIG. 12E is a representation of a computer display showing a General Exchange/General Case Info—Other Lawsuits and the Statute of Limitations. Any information entered by the user concerning the existence of other personal injury lawsuits brought by the claimant and the date the statute of limitations began to run on the claimant's claims will be displayed on this screen. To edit or add information concerning special damages, the user clicks on the “Edit” button, which produces the screen as in FIG. 12F.

FIG. 12F is a representation of a computer display showing a screen for editing or entering information concerning General Exchange/General Case Info — Other Lawsuits and the Statute of Limitations. The user enters the information, clicks on “Save” and is returned to the screen in FIG. 12E, which now displays the newly entered information or reflects the editing just done.

FIG. 12G is a representation of a computer display showing a General Exchange/General Case Info—Military service of the claimant. Any information entered by the user concerning whether the claimant served in the military, the service branch in which he or she served, any decorations, and discharge status will be displayed on this screen. To edit or add information concerning special damages, the user clicks on the “Edit” button, which produces the screen as in FIG. 12H.

FIG. 12H is a representation of a computer display showing a screen for editing or entering information concerning General Exchange/General Case Info — Military service of the claimant. The user enters the information, clicks on “Save” and is returned to the screen in FIG. 12G, which now displays the newly entered information or reflects the editing just done.

FIG. 12I is a representation of a computer display showing a General Exchange/General Case Info—smoking history of the claimant. Any information entered by the user concerning whether the claimant smoked cigarettes or cigars, the number of cigarettes or cigars smoked on a daily basis, and the date started and stopped will be displayed on this screen. To edit or add information concerning special damages, the user clicks on the “Edit” button, which produces the screen as in FIG. 12J.

FIG. 12J is a representation of a computer display showing a screen for editing or entering information concerning General Exchange/General Case Info—smoking history of the claimant. The user enters the information, clicks on “Save”and is returned to the screen in FIG. 12G, which now displays the newly entered information or reflects the editing just done.

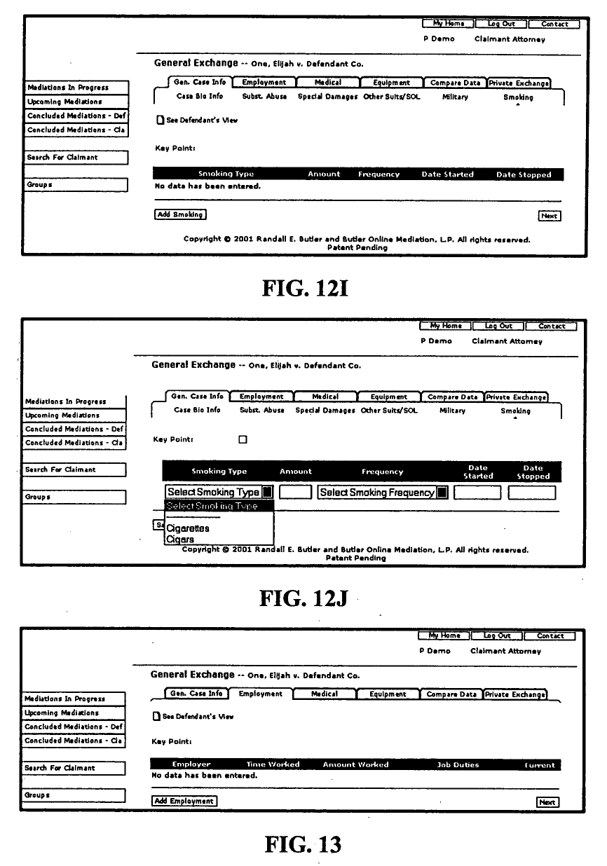

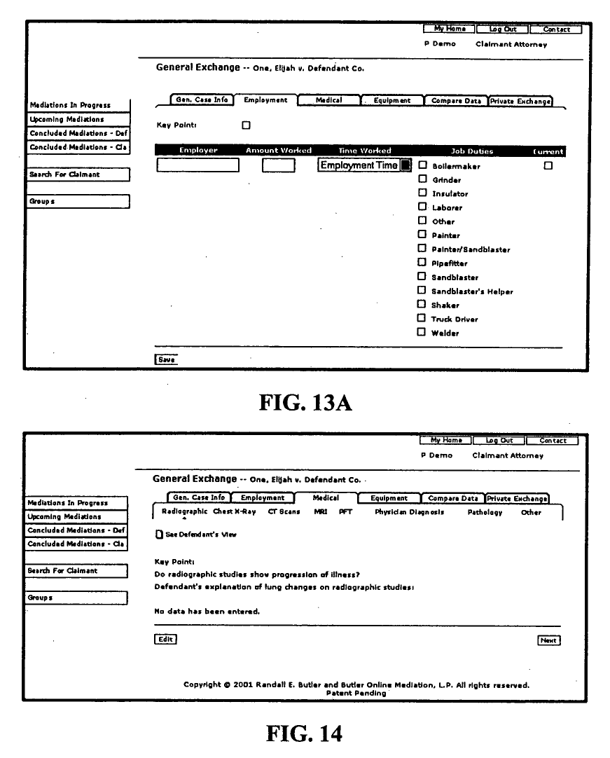

FIG. 13 is a representation of a computer display showing a General Exchange for employment information. By clicking on the “Add Employment” button, the user is taken to the screen depicted in FIG. 13A, a representation of a computer display showing the method for inputting name of employer, time worked there, and job duties. After entering requested information on the edit screen in FIG. 13A, the user clicks on the “Save” button and the user is returned to the screen in FIG. 13 which now displays the saved information.

FIG. 14 is a representation of a computer display showing a General Exchange for medical information—radiographic studies for the claimant, including whether the claimant's radiographic studies demonstrate progression of illness and the defendants' explanation of any abnormal findings on the claimant's radiographs.

FIG. 14A is a representation of a computer display showing a screen for editing or inputting General Exchange/medical information—radiographic studies for the claimant, including whether the claimant's radiographic studies demonstrate progression of illness and the defendants' explanation of any abnormal findings on the claimant's radiographs. After entering requested information on the edit screen in FIG. 14A, the user clicks on the “Save” button and the user is returned to the screen in FIG. 14 which now displays the saved information.

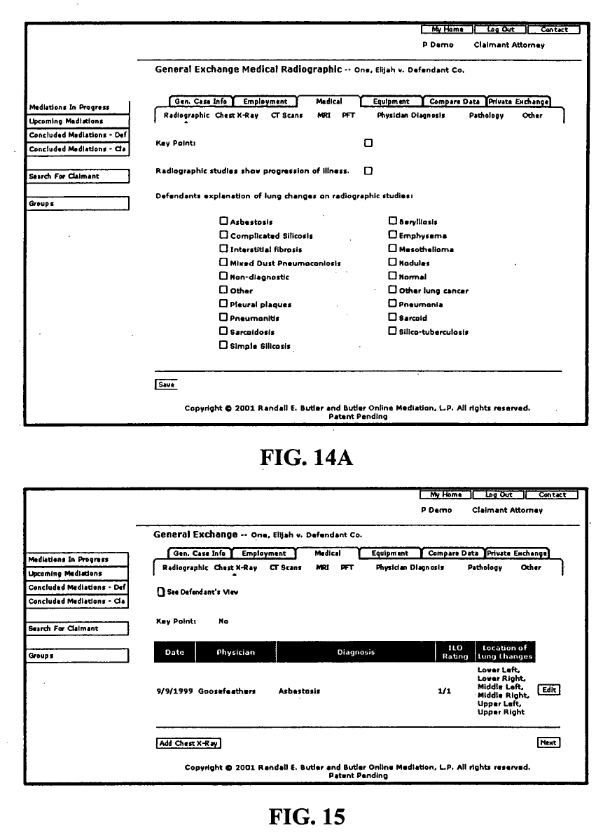

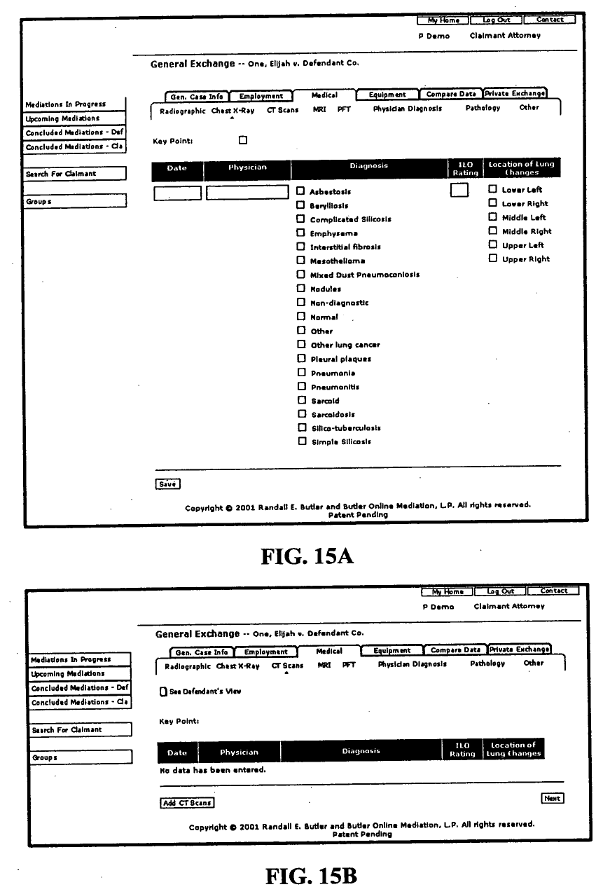

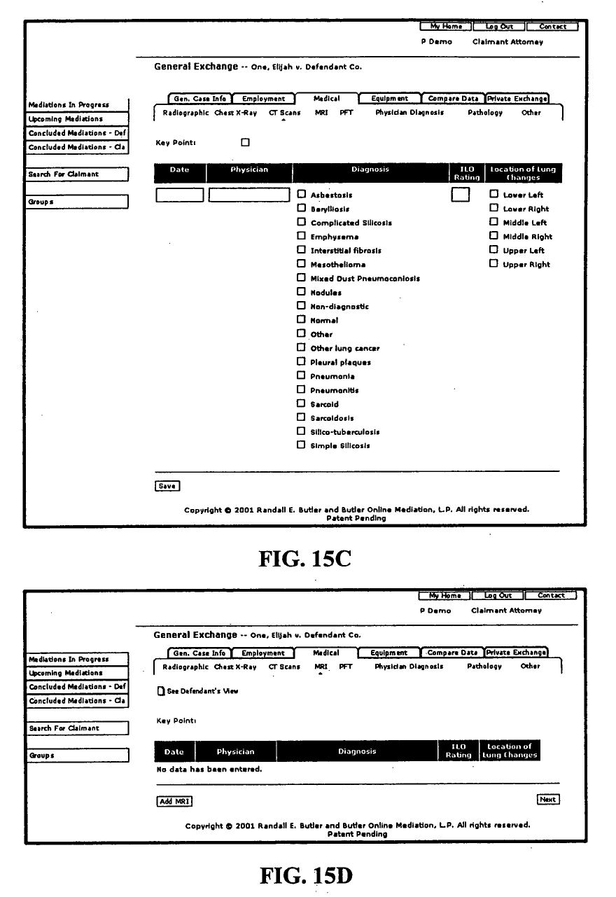

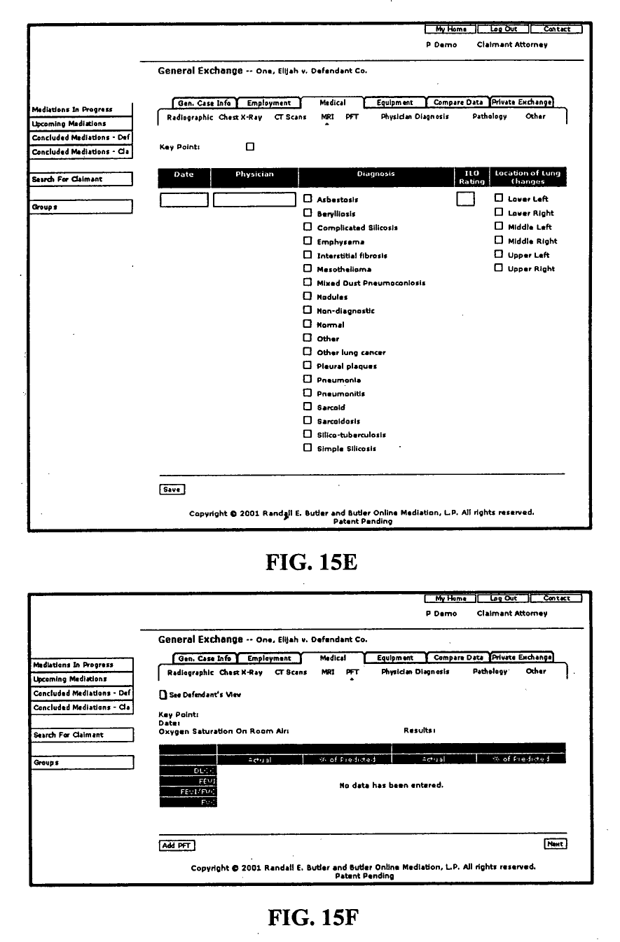

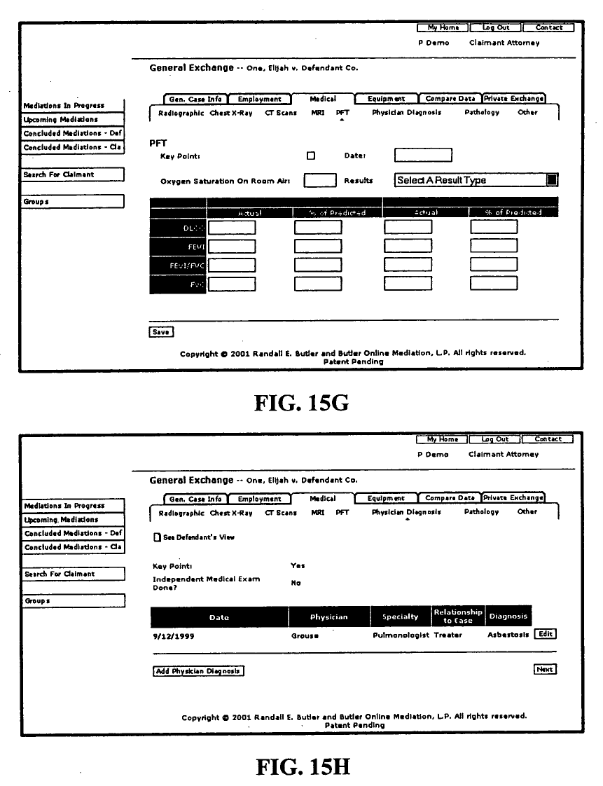

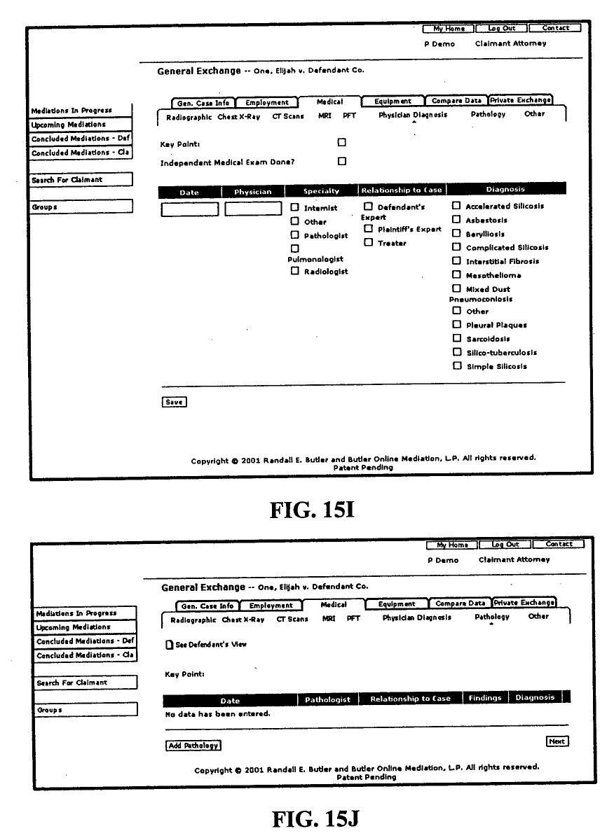

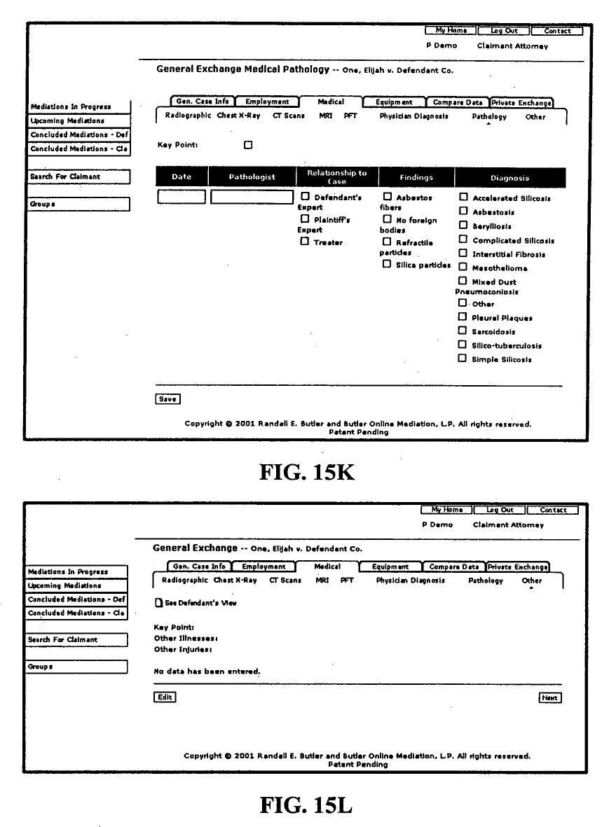

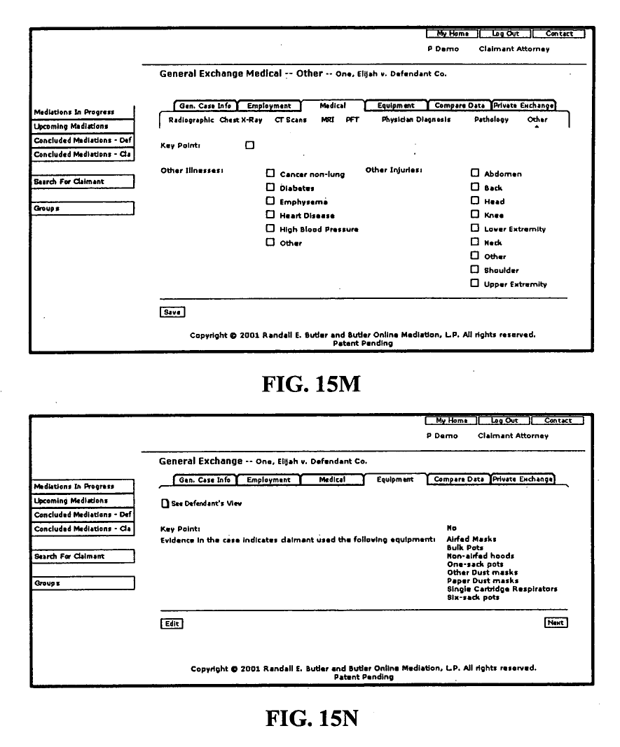

FIG. 15 is a representation of a computer display showing a General Exchange/medical information—chest x-rays for the claimant, including date of the x-ray, physician reading the x-ray, diagnosis on the x-ray, and location of changes in the lung fields.

FIG. 15A is a representation of a computer display showing a screen for editing or inputting General Exchange/medical information—chest x-rays for the claimant, including date of the x-ray, name of physician reading the x-ray, diagnosis on the x-ray, and location of changes in the lung fields. After entering requested information on the edit screen in FIG. 15A, the user clicks on the “Save” button and the user is returned to the screen in FIG. 15 which now displays the saved information.

FIG. 15B is a representation of a computer display showing a General Exchange/medical information—lung CT scans for the claimant, including date of the CT scan, physician reading the CT scan, diagnosis on the CT scan, and location of changes in the lung fields.

FIG. 15C is a representation of a computer display showing a screen for editing or inputting General Exchange/medical information—lung CT scans for the claimant, including date of the CT scans, name of physician reading the CT scans, diagnosis on the CT scans, and location of changes in the lung fields. After entering requested information on the edit screen in FIG. 15C, the user clicks on the “Save” button and the user is returned to the screen in FIG. 15B which now displays the saved information.

FIG. 15D is a representation of a computer display showing a General Exchange/medical information —0 lung MRI scans for the claimant, including date of the MRI scan, physician reading the MRI scan, diagnosis on the MRI scan, and location of changes in the lung fields.

FIG. 15E is a representation of a computer display showing a screen for editing or inputting General Exchange/medical information—lung MRI scans for the claimant, including date of the MRI scans, name of physician reading the MRI scans, diagnosis on the MRI scans, and location of changes in the lung fields. After entering requested information on the edit screen in FIG. 15E, the user clicks on the “Save” button and the user is returned to the screen in FIG. 15D which now displays the saved information.

FIG. 15F is a representation of a computer display showing a General Exchange/medical information—PFT (pulmonary function studies) for a claimant.

FIG. 15G is a representation of a computer display showing a screen for editing or inputting General Exchange/medical information—PFT (pulmonary function studies) for a claimant. After entering requested information on the edit screen in FIG. 15G, the user clicks on the “Save” button and the user is returned to the screen in FIG. 15F which now displays the saved information.

FIG. 15H is a representation of a computer display showing a General Exchange/medical information—physician diagnosis for a claimant, including the name of the physician, physician's relation to the case, physician's specialty and his or her diagnosis of the condition of the claimant.

FIG. 15I is a representation of a computer display showing a screen for editing or inputting General Exchange/medical information—physician diagnosis for a claimant, including the name of the physician, physician's relation to the case, physician's specialty and his or her diagnosis of the condition of the claimant. After entering requested information on the edit screen in FIG. 15I, the user clicks on the “Save” button and the user is returned to the screen in FIG. 15H which now displays the saved information.

FIG. 15J is a representation of a computer display showing a General Exchange/medical information—Pathology for a claimant, including the name of the physician, physician's relation to the case, pathology findings and his or her diagnosis of the condition of the claimant.

FIG. 15K is a representation of a computer display showing a screen for editing or inputting General Exchange/medical information—Pathology for a claimant, including the name of the physician, physician's relation to the case, pathology findings and his or her diagnosis of the condition of the claimant. After entering requested information on the edit screen in FIG. 15K, the user clicks on the “Save” button and the user is returned to the screen in FIG. 15J which now displays the saved information.

FIG. 15L is a representation of a computer display showing a General Exchange/medical information—Other illnesses and injuries for a claimant.

FIG. 15M is a representation of a computer display showing a screen for editing or inputting General Exchange/medical information—Other illnesses and injuries for a claimant. After entering requested information on the edit screen in FIG. 15M, the user clicks on the “Save” button and the user is returned to the screen in FIG. 15L which now displays the saved information.

FIG. 15N is a representation of a computer display showing a General Exchange/equipment information, stating the kinds of equipment used by the claimant during his exposures periods.

FIG. 15O is a representation of a computer display showing a screen for editing or inputting General Exchange/equipment information, stating the kinds of equipment used by the claimant during his exposures periods. After entering requested information on the edit screen in FIG. 15O, the user clicks on the “Save” button and the user is returned to the screen in FIG. 15N which now displays the saved information.

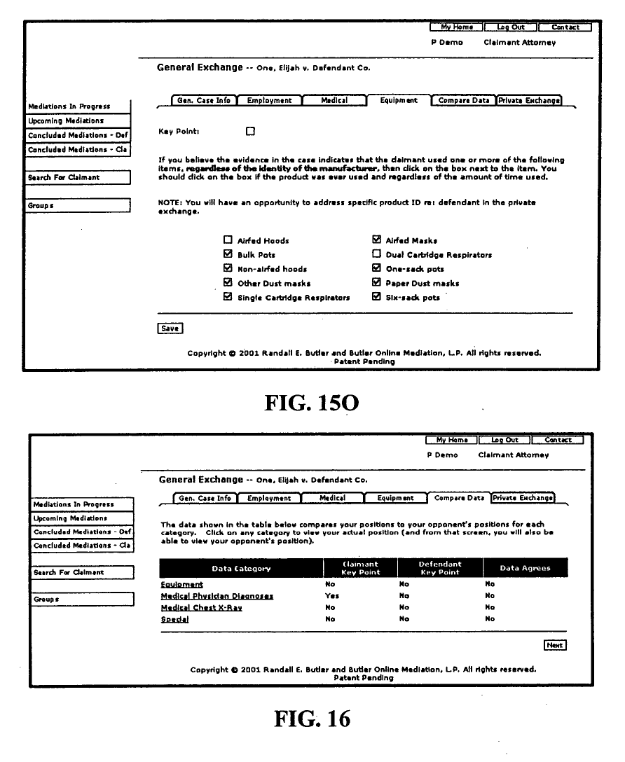

FIG. 16 is a representation of a computer display showing a General Exchange comparison of data. By clicking on the linked Data Category, such as Medical Chest X-Ray, the user can go to the screen in the General Exchange which is at variance with the same screen as submitted by the opposition.

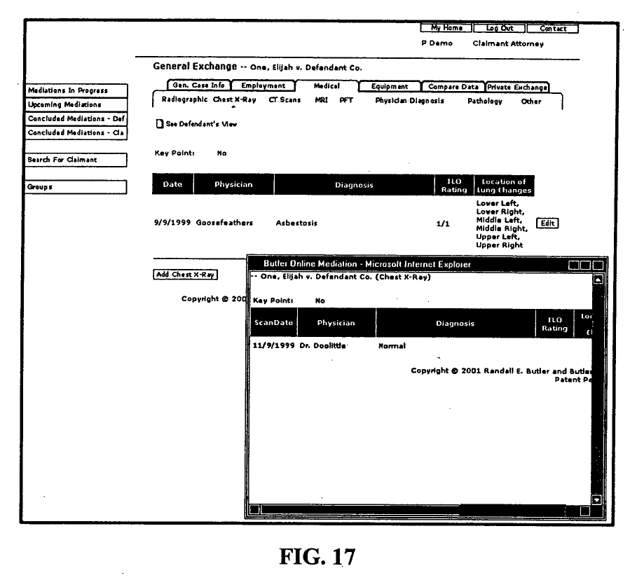

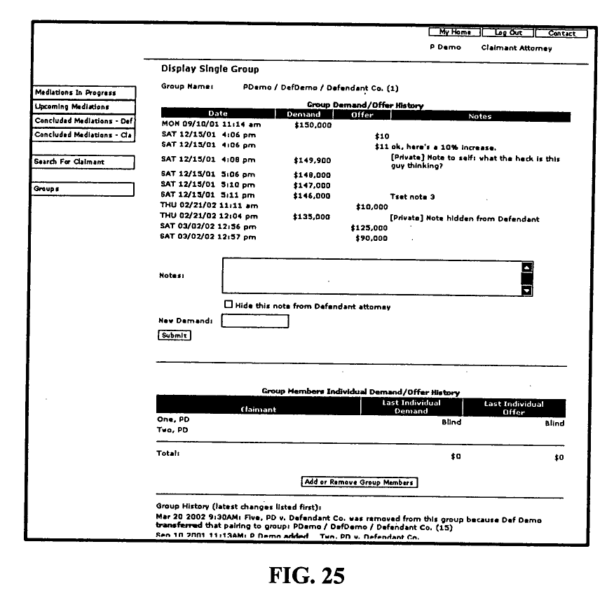

FIG. 17 is a representation of a computer display showing a variance of medical information. In response to receiving a click on “See Defendant's View,” the system displays a screen as depicted in FIG. 25 to the user.

Exchanging Private Dispute Information

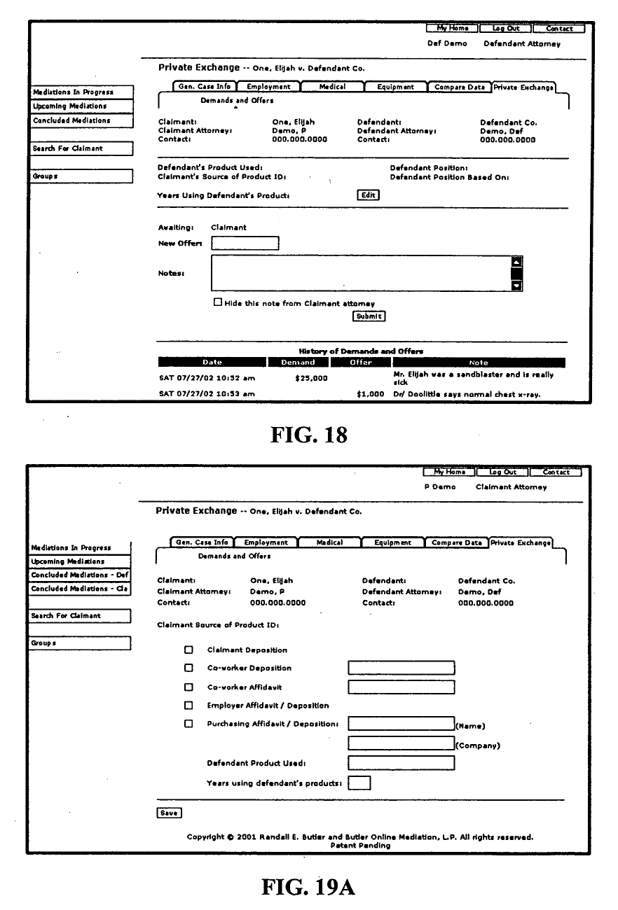

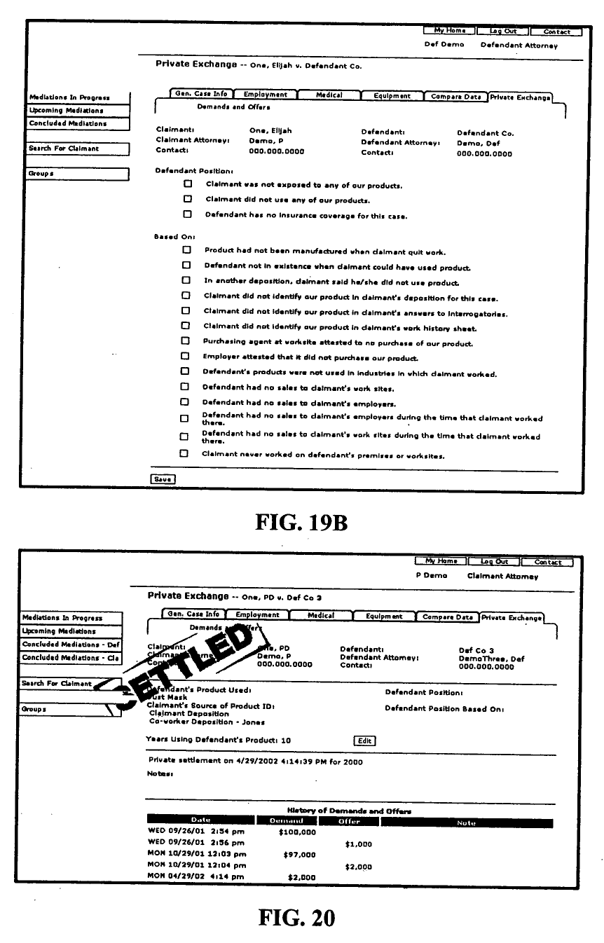

The inventive system and method also provides an interface through which a disputant representative may record information that is not to be generally shared with all other disputant representatives. This interface is referred to as the Private Exchange. FIG. 18 depicts a representation of a computer display showing a Private Exchange wherein an attorney for a claimant and similarly for a defendant may enter specific information particular to their clients as it relates to the particular dispute. FIG. 19A is a representation of a computer display showing a screen used for inputting information by the Claimant Attorney on the Private Exchange screen concerning product usage by the claimant specific to the Defendant. FIG. 19B is a representation of a computer display showing a screen used for inputting information by the Defendant Attorney on the Private Exchange screen concerning product nonusage by the claimant of specific products of the Defendant.

Unlike the General Exchange, the Private Exchanges are a one-to-one exchange of information, that is, from one disputant to another disputant. For example, the Private Exchange data are viewable only by the defendant's attorney who represents the defendant for a dispute, with a particular claimant's attorney who represents the claimant for the same dispute.

If a disputant representative represents more than one disputant for a particular dispute, for example, one attorney representing multiple defendants, he selects the specific disputant/defendant mediation pairing from the Mediations in Progress screen (FIG. 10) and then clicks on the Private Exchange tab. The Private Exchange information entered by the claimant representative related to the particular defendant will then be presented.

Similarly, a claimant's attorney accesses the Private Exchange tab for a particular claimant/defendant pairing by clicking on claimant/defendant pairing on the Mediations in Progress screen (FIG. 10) and then clicking on the Private Exchange tab.

Depending on the type of user, defendant's attorney or claimant's attorney, the fields displayed on the screen may be editable or read-only. In other words, the disputant representative may edit the data that he entered and only view the data that the opposing disputant representative entered.

In one embodiment, pre-defined questions and answers are provided for input by the system by the Mediator. For example, in an silicosis or asbestos case some questions that may be presented to a plaintiff's attorney include:

What particular product of the defendant that is a party to the private exchange was used by the claimant?

What years was the product used?

During which years was the claimant exposed to a particular product?

Who is the witness that will establish such usage and/or exposure?

Some questions that may be presented to a defendant's attorney include:

Is it the defendant's position that the claimant never used or was exposed to a product manufactured or sold by the defendant?

If so, what is that position based on?

Similar to the General Exchange, the inventive system may be configured such that particular questions are presented in the Private Exchange depending on the type of dispute. Additionally, the inventive system may by configured to allow a disputant representative to enter their own questions of interest and corresponding range and value of answers which may then be saved into a database.

Uploading of Documents and Input of Information

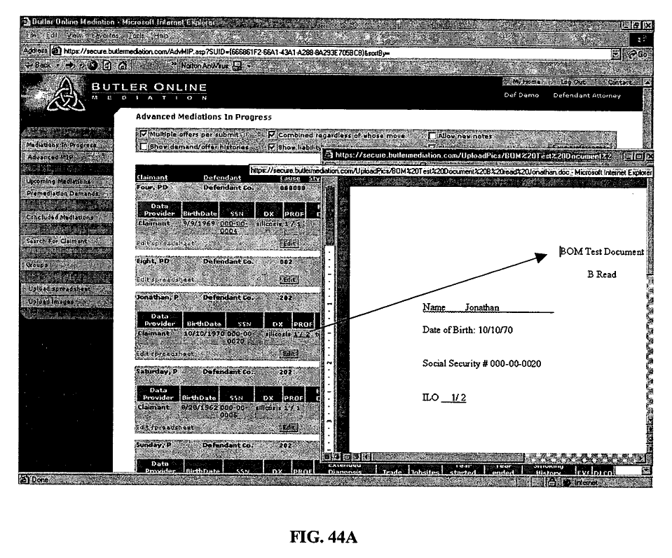

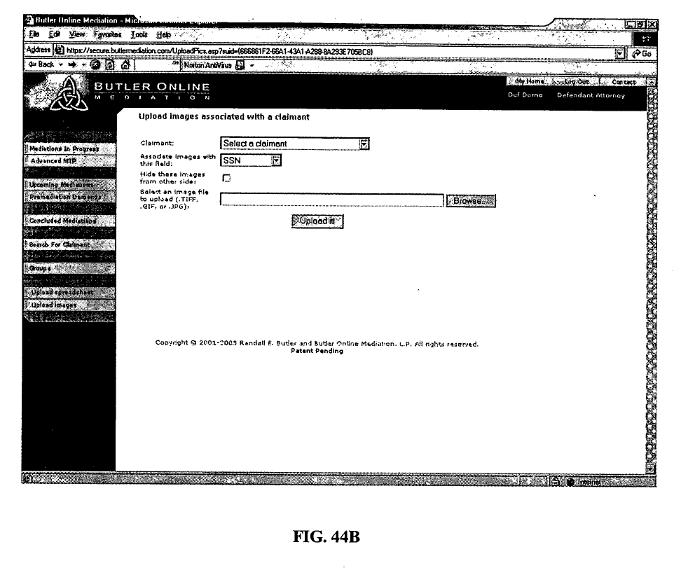

Referring now to FIGS. 44A-B, the system allows uploading and display of critical documents that are sources for the evaluative criteria. FIG. 44A shows a evidentiary document linked to a particular field. The image is hyperlinked to the particular information displayed in the field. By clicking on the data displayed in the field, the particular image or document associated with the field will be displayed. FIG. 44B exemplifies one embodiment for attaching images or documents to a field. The fields depicted are “Claimant”, “Associate Images with this field”, “Hide these images from other side”, and “Select an image file to upload”. The dropdown list box for the “Claimant” field displays the particular claimants to the dispute. The user selects the Claimant where the image should be attached as shown in FIG. 44B. The user then selects the particular field where the image or document should be attached. Next the user select an image or document to be added by selecting the “Browse” button next to the field Select an image file to “upload”. The “Browse” button will display a screen that allows the user to select a file from the directory or list of files. When the user has selected the appropriate file, to attach it to the particular field, the user selects the “Upload it!” button.

In addition to inputting information into fields, the evaluative information may also be input into the system by inputting data that has been previously entered into a spreadsheet. For example, the spreadsheet sets forth particular fields where the user may enter in information. Once the user has entered the information, the system allows the user to upload the information from the spreadsheet into the system. Utilizing the spreadsheet provides a convenient method to allow a user of the system to load significant amount of information. For example, the plaintiff's attorney may list the names of all the defendants and their related information in the spreadsheet. The system will then allow this information to be added to the particular dispute and create claimant/defendant pairings as identified in the spreadsheet.

Making Offers and Demands

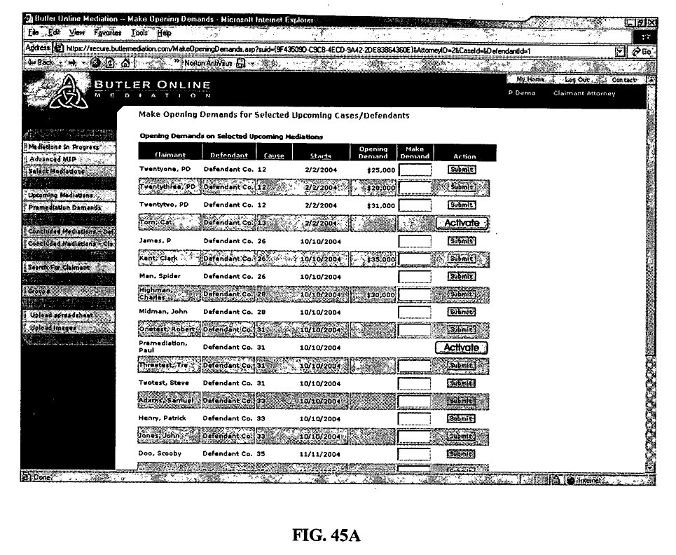

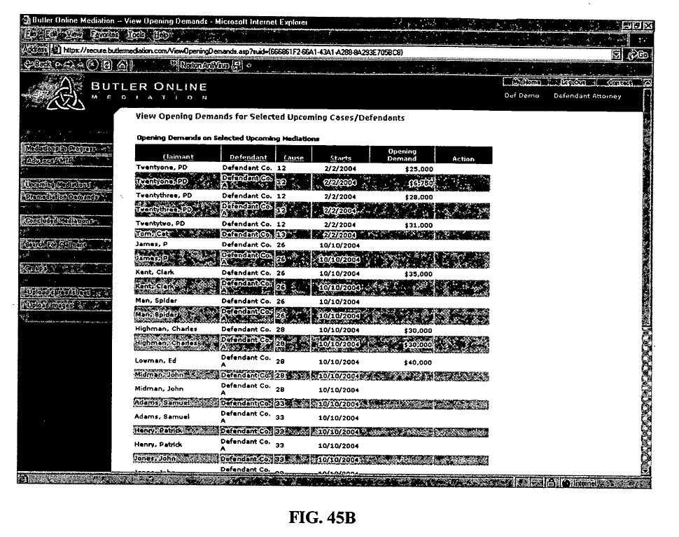

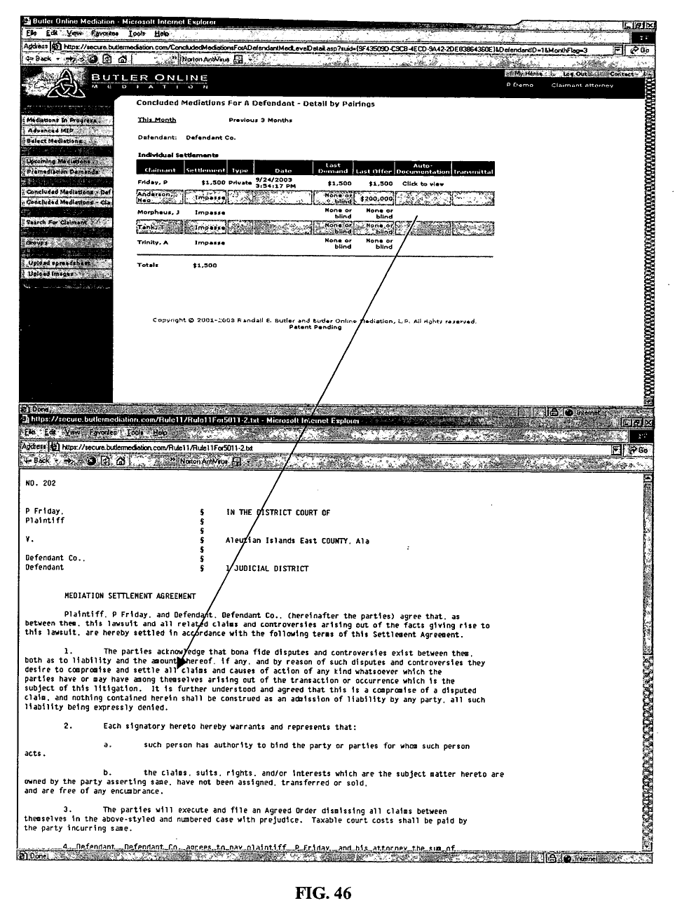

The resolution of a dispute often times requires payment of an amount of money from one disputant to another disputant. The resolution of a dispute often times requires payment of an amount of money from one disputant to another disputant. Referring now to FIGS. 45 A-B, prior to initiating a mediation, pre-mediation demands may be made. For example, a claimant's attorney may input and display pre-mediation demands for access by defendant users. Demands may be posted through this function, and viewed by the defendant users, any time prior to the official commencement of an online mediation.

As shown in FIG. 18, within each Private Exchange, a disputant representative may engage in settlement negotiations by making offers or demands. A demand is also referred to as a counter-offer. As demands/offers are made they are displayed to the user via a section of the screen for “Demands” and “Offers” along with date information. The screen also alerts the attorney user as to whose turn it is to make an offer or demand. For example, an attorney for a defendant in the Private Exchange may enter a formal offer to a claimant by entering a particular settlement amount. The attorney for the claimant enters into the system a demand to that defendant's offer by entering a particular settlement amount into the Private Exchange screen. Thus, the attorney for the claimant and each defendant may carry on individual negotiations remotely from one another through the, inventive system.

The disputant representatives may utilize various settlement rules to determine when a settlement of the dispute has been reached. One such settlement rule is that an offer and demand must be of equal value to reach settlement of the dispute. The following sets forth an example interaction between a claimant representative and a defendant representative in the settlement of a dispute. A disputant representative for a claimant may first offer $100,000 to settle the dispute. The offer would be entered into a program interface configured to receive the settlement offer. The settlement offer is then stored in the database. The inventive system may then alert the defendant's that an offer for settlement has occurred. This alert may be via an e-mail, printed notification, paged message, or a message may be displayed to or be retrievable by the defendant's representative. The defendant's representative may accept the settlement amount by accepting the amount, i.e. by entering the same amount as a demand. Alternatively, the defendant's representative may make a demand for a different amount, for example $50,000 to settle the dispute. This counter-offer amount will then be stored in the database. Notification of the counter-offer may then be sent to claimant's representative. Claimant's representative may then accept the counter-offer or make a new offer. The offer/counter-offer process continues until the parties have come to an agreement as to the settlement amount.

FIG. 20 is a representation of a computer display showing a Private Exchange with a settled dispute. In one embodiment, when a dispute is settled according to the particular settlement rules utilized for the mediation, a “Settled” stamp is displayed on the Private Exchange screen. Other visual or auditory cues may be utilized to instruct the user that the particular dispute has been settled. The pairing and the results of the settlement would then be displayed on the Concluded Mediations screen.

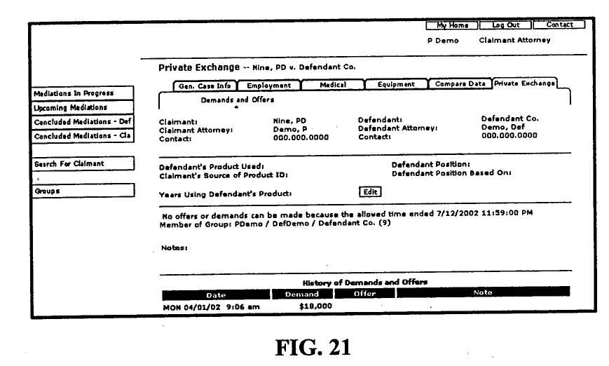

Regardless of the type of settlement rules the disputant representatives chose to use, the mediator may set a time duration for which the settlement negotiations will end or the parties may choose a negotiation period. The time duration may be set as any period such as seconds, minutes, hours, days, weeks, months and years or combinations thereof. The inventive system may provide a message or time display indicating the remaining duration of the settlement negotiations. Referring to FIG. 21, if the end-date of a mediation has passed, the system will prompt the Attorney with a message on the Private Exchange Screen that indicates that no additional offers or demands can be made. The system may be configured such that Registrar or Mediator may reactivate the mediation (for example, when a reactivation fee is paid to continue the negotiation).

Group Negotiation.

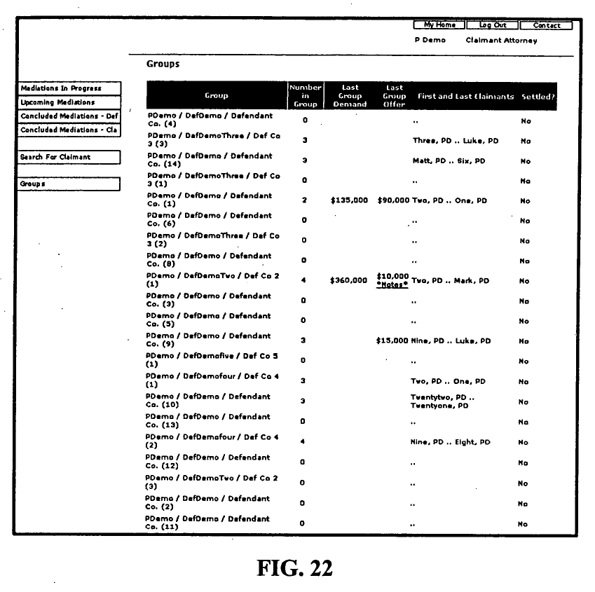

Attorneys can make aggregate offers and demands by first creating groups and then negotiating settlements between a single defendant and a group of plaintiffs represented by a single claimant's attorney. FIGS. 22-25 depict representations of screens that dispute representatives may use to create groups, add or subtract individual claimants from a group, and make offers and demands in reference to the groups.

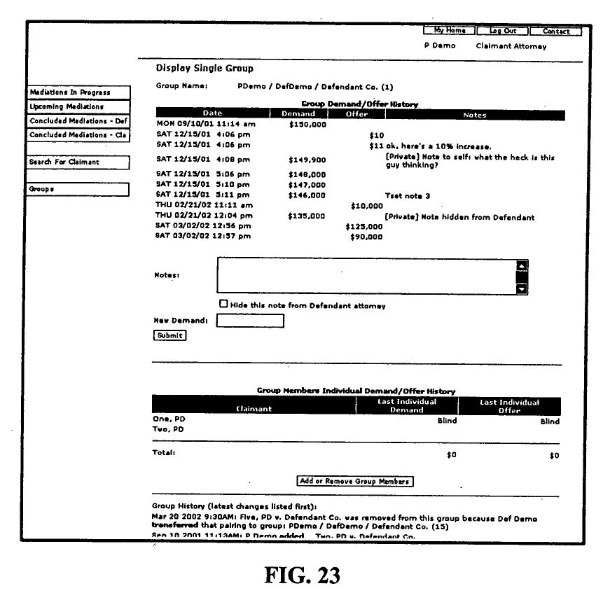

FIG. 22 is a representation of a computer display showing an exemplary list of groups. By clicking on the name of a group, the attorney will be taken to a screen (as shown in FIG. 23) displaying information for that particular group.

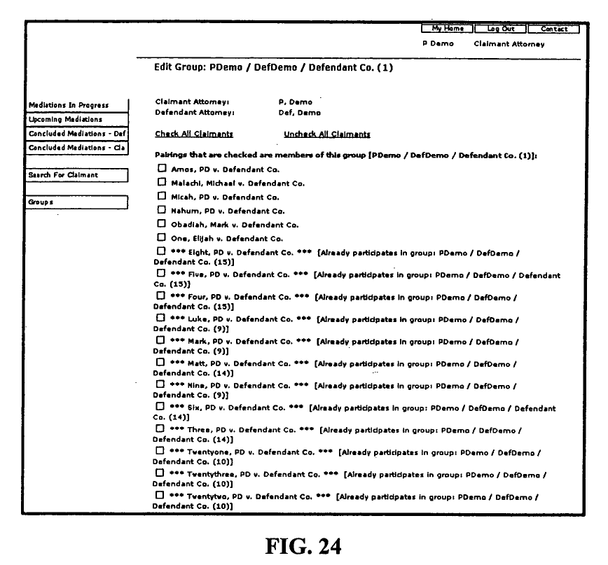

FIG. 23 is a representation of a computer display showing information for a particular group. The single group screen shows all claimants who are members of a particular group, the individual offers and demands for each claimant, the group offers and demands intended to settle all members of the group, and a history of the group (including information such as what member was added or removed, the date and time of such, the user that performed the addition and/or removal). Selecting the “Add or Remove Group Members” button, displays a screen allowing the user to maintain a group (see FIG. 24).

The Display Single Group screen (FIG. 23) allows for the entry of new group offers/demands into an input box. As an offer/demand is made, the amount of the offer/demand is recorded in the database and is also displayed in the “Group Demand/Offer History” section in the upper right hand corner of the screen. The Mediations in Progress screen when accessed, will then display the fact that a group offer or demand that has been made, but not the amount.

FIG. 24 is a representation of a computer display for editing a group. The attorney can add or remove members from the group by checking or unchecking the boxes next to the “Claimant—Defendant” pairings. There are also functions (“Check all Claimants” and “Uncheck all Claimants”) for deleting all members from the group or adding all claimants to the group. When the “Save” button is clicked, the changes made by the attorney are saved to the database, and the user is returned to the “Display Single Group” screen (See FIG. 23) (Note that the example data in FIGS. 23 and 24 are for two different attorney users. The example attorney Carl Duck would be taken back to the Display Single Group for his cases and the group that he had just edited.)

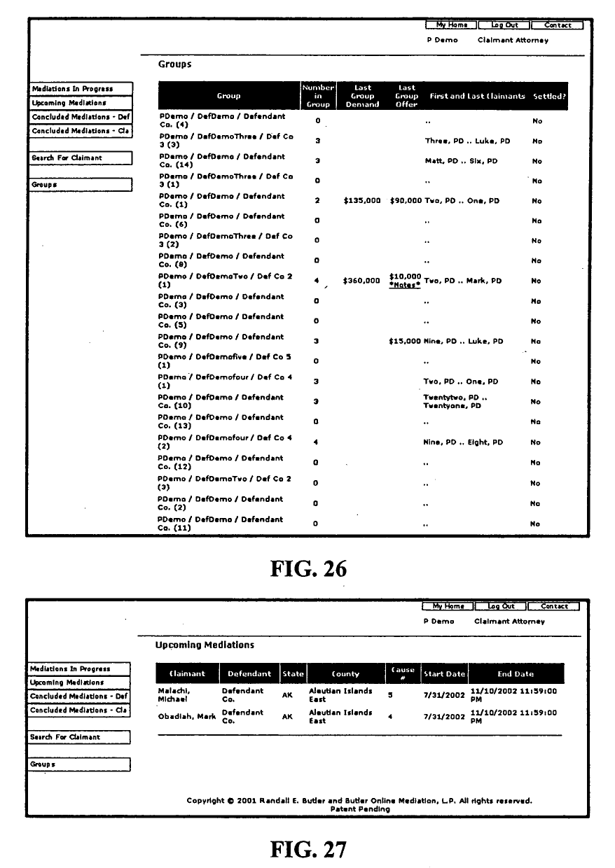

In one embodiment, a group number (which may be alphanumeric) may be assigned by the system for group negotiations. Only one number may be assigned for each group of claimants. When the Group Offer tab is selected the user is taken to Groups screen (FIG. 26), the Groups screen shows all groups in which the user's client is participating. By clicking on the name of the group, the user is taken to the Display Single Group screen (FIG. 23).

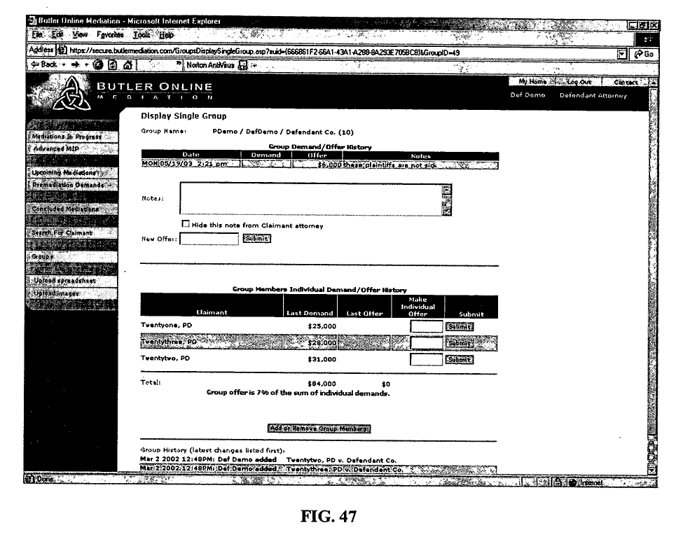

Referring now to FIG. 47, the figure shows a representation of a computer display for Group Demand/Offers. Defendants may enter aggregate offers to a group of plaintiffs and receive individual demands for the plaintiffs in the designated group. The system compares the sum of the individual demands to the aggregate offer. When the sum of the individual demands is equal to the aggregate offer, the pairings in the group automatically settle.

Reporting Information to Dispute Participants

The inventive system includes a number of reports that may be generated or displayed to a dispute representative. The inventive system and method lends itself to the generation of various reports, although not specifically identified below. Reports, for example, may be generated that includes the data that a particular dispute representative may access on-line. The Mediator has access to a number of different reports for administrative purposes, including all screens available to the Registrar.

The system also includes reports available to the Mediator that list each pairing in which there has been no new offer or demand over an amount of time to be specified by the Mediator. These reports make it possible for the Mediator to better monitor the progress of mediation pairings online and intervene to encourage the negotiations of the involved parties and their representatives. These reports also include auto-email functions to facilitate communication by the Mediator with the representatives of the parties.

Claimant's Attorney Reports

The attorney for the claimant may access a report that summarizes the last offer made by each of the defendants to that claimant within a claim and the corresponding counter-offer or demands. In addition, the attorney for the claimant can access a report summarizing the total amounts offered on each of the disputes in which he represents the claimant. The report lists each defendant in a given claim. All demands to each defendant and each offer from a defendant are shown next to corresponding defendant. A claimant's attorney may generate a report of all offers, counter-offers or demands and settlement amounts for a given claimant. Other reports include: 1) a summary of claimant/defendant mediation pairings in progress involving clients of the attorney user, including the time left to mediate the case online, the amount of the latest offer or demand to settle that pairing, an indication as to whose turn it is to make an offer or demand, whether group demands or offers have been made involving that claimant/defendant, a input box for making another offer or demand to settle that mediation pairing, and the ability to access the General Exchange and Private exchange for that pairing directly from that screen; 2) Upcoming Mediations—a list of mediations with start dates still in the future; 3) a summary of concluded mediation pairings, including whether the mediation settled, the settlement amount, and the last offer and demand if the case did not settle; 4) a summary of the mediation activity for all claimants represented by a particular claimant attorney (accessible only by the particular claimant attorney representing those claimants); 7) a summary of mediations involving a particular claimant with all defendants; and 8) a summary of all Group mediations involving clients of a particular attorney, including the results of mediation.

Defendant Attorney's Report

The attorney for a defendant may access a report of all demands to his particular defendant made by all claimants in all claims in which the claimants are represented by the same attorney. Defendant's representative may request a report of all of the current offers, demands and/or settlement amounts between that particular defendant and all of the claimants represented by a particular claimant's attorney. Other reports include: 1) a summary of claimant/defendant mediation pairings in progress involving clients of the attorney user, including the time left to mediate the case online, the amount of the latest offer or demand to settle that pairing, an indication as to whose turn it is to make an offer or demand, whether group demands or offers have been made involving that claimant/defendant, a input box for making another offer or demand to settle that mediation pairing, and the ability to access the General Exchange and Private exchange for that pairing directly from that screen; 2) Upcoming Mediations—a list of mediations with start dates still in the future; 3) a summary of concluded mediation pairings, including whether the mediation settled, the settlement amount, and the last offer and demand if the case did not settle; 5) a summary of the mediation activity of all defendants represented by a particular defendant attorney and accessible only by that defendant attorney; 6) a summary of the mediation activity for all claimants with a specific defendant represented by a particular defendant attorney and accessible only by that defendant attorney, including settlement amounts, and if impasse is reached, last offer and demand; and, 8) a summary of all Group mediations involving clients of a particular attorney, including the results of mediation

Claimants' Settlement Matrix

In one embodiment, the attorney for the claimant may access a settlement matrix containing information from all key evaluative fields for each of her claimants, as well as the amounts of offers, demands and settlements for any given defendant relative to a particular claimant.

Defendant's Settlement Matrix

In one embodiment, a defendant attorney may access a settlement matrix for all claims negotiated on the system with a particular claimant's attorney. The matrix contains information from each of the evaluative fields relative to each claimant as well as offers, demands, and settlement amounts.

Claimants' Evaluation Matrix

In one embodiment, the attorney for the claimant may access an evaluation matrix which will analyze his/her clients' claims based on key evaluative criteria entered in the system through the General Exchange Data provided in each of the evaluative criteria categories will be given weighted values based on analysis of prior disputes of claimants represented by the same attorney that were resolved through the inventive system. An algorithm or mathematical calculation will be applied based on the weighted values that will provide a comparative evaluation vis-à-vis other claimants represented by the same attorney.

FIG. 27 is a representation of a computer display showing an exemplary list of upcoming mediations registered on the system. Attorney users may access a list of registered mediations with start dates in the future and involving their clients in cases in which they are registered as attorney of record. The upcoming mediations report may be accessed by clicking the corresponding tab on the screen.

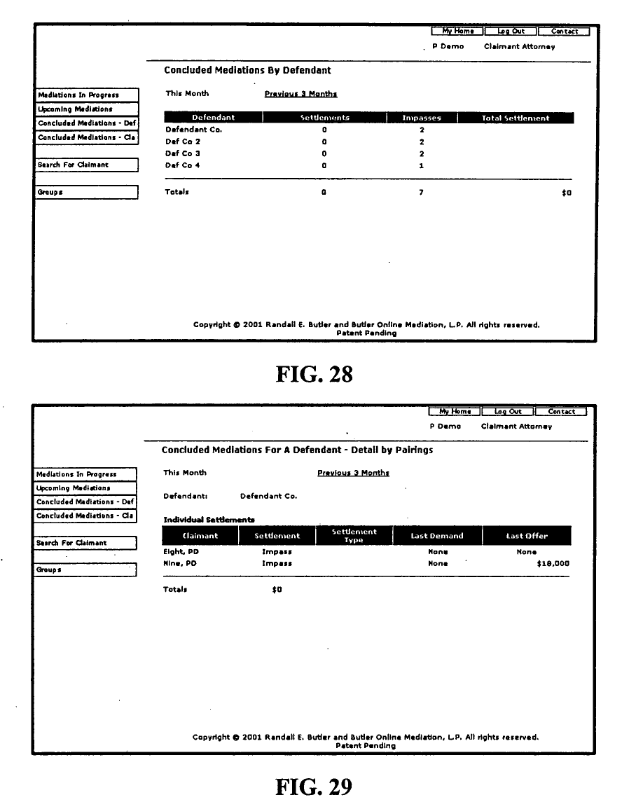

FIG. 28 is a representation of a computer display showing an exemplary list of concluded mediations by defendant. This concluded mediations report may be accessed by clicking the corresponding tab on the screen. The attorney may click on the name of the defendant to access information concerning the individual pairings involving that defendant (see FIG. 29). This report is accessible by the disputant representative for all of the defendants that the disputant representative represents. Additionally, the Mediator or the authorized Registrars may access the report. The Mediator may also select that the report show all concluded mediations based on various criteria, such as attorney that represents the defendants, date or date range of concluded mediations, settlement amounts, and other data and combinations thereof of data related to a concluded mediation.

FIG. 29 is a representation of a computer display showing an exemplary list of concluded mediations for a particular defendant. Detail by pairings shows the status (settled or impasse) of all mediations that have passed the end-date for the mediation. If the case has settled, it shows the manner of the settlement—private, or group. This report is accessible by the disputant representative for the defendant. Additionally, the Mediator or the authorized Registrars may access the report.

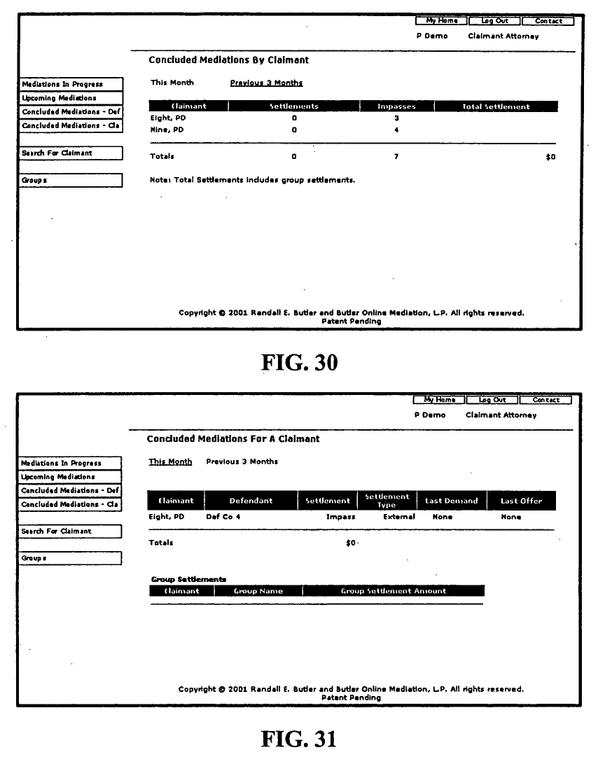

FIG. 30 is a representation of a computer display showing an exemplary list of concluded mediations by claimant. This concluded mediations report may be accessed by clicking the correspond tab on the screen. The attorney may click on the name of the defendant to access information concerning the individual pairings involving that defendant (see FIG. 31). This report is accessible by the claimant representative for all of the claimants that the disputant representative represents. Additionally, the Mediator or the authorized Registrars may access the report. The Mediator may also select that the report show all concluded mediations based on various criteria, such as attorney that represents the claimants, date or date range of concluded mediations, settlement amounts, and other data and combinations thereof of data related to a concluded mediation.

FIG. 31 is a representation of a computer display showing an exemplary list of concluded mediations for a particular claimant. Detail by pairings shows the status (settled or impasse) of all mediations that have passed the end-date for the mediation. If the case has settled, it shows the manner of the settlement—private, or group. This report is accessible by the disputant representative for the claimant. Additionally, the Mediator or the authorized Registrars may access the report.

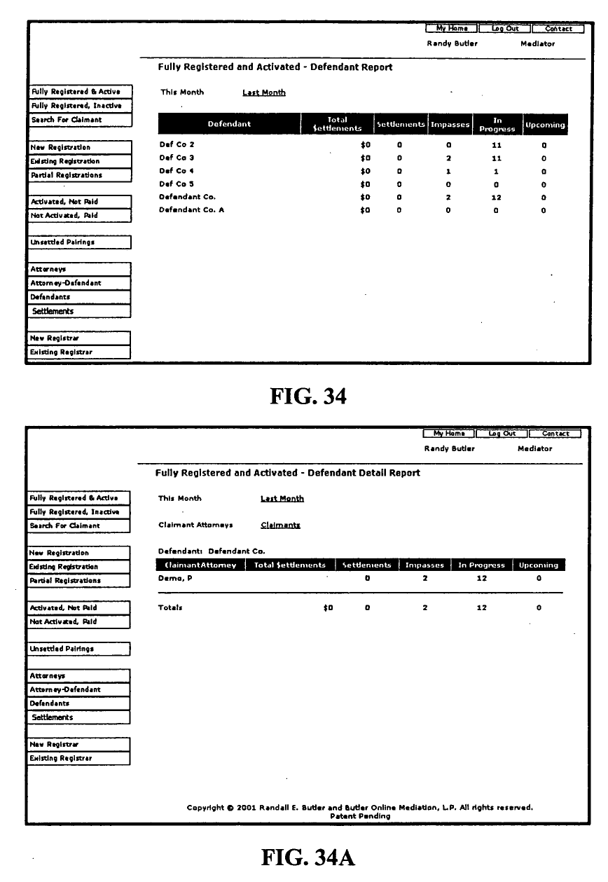

FIG. 34 is a representation of a computer display showing a list of fully registered and activated, defendant report. The Mediator has access to reports of all cases registered in the system. This screen provides the Mediator aggregate information on activity in the current month or the prior month on a defendant-by-defendant basis. By clicking on the name of the defendant, the Mediator is taken to the next screen providing more specific information about that defendant's cases (FIG. 34A.)

FIG. 34A is a representation of a computer display showing a list of fully registered and activated, defendant detail report. This screen provides the Mediator with information concerning the activity in cases involving the particular defendant named on the screen and each of the claimant attorneys representing claimants in pairings with that defendant.

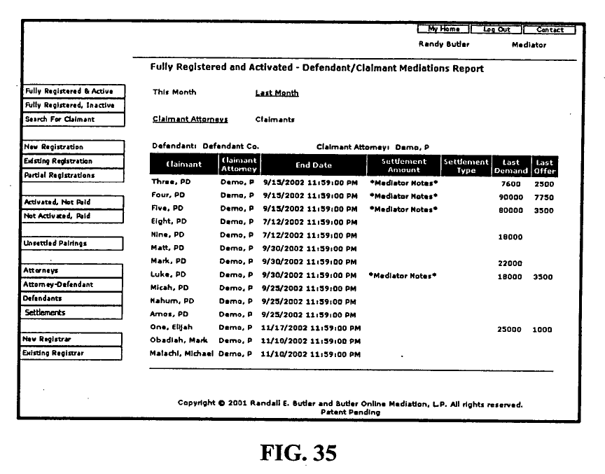

FIG. 35 is a representation of a computer display showing a list of fully registered and activated, defendant/claimant mediations report. This screen provides the status of all of the current month's and previous month's pairings for a particular defendant and paired claimants and the claimants' representatives. In response to a selection of the name of a displayed claimant, the system will present the Mediator with the General Exchange and Private Exchange screens for the particular defendant/claimant pairing. Also, the report is available for a particular claimant and the paired defendants and the defendants' representatives.

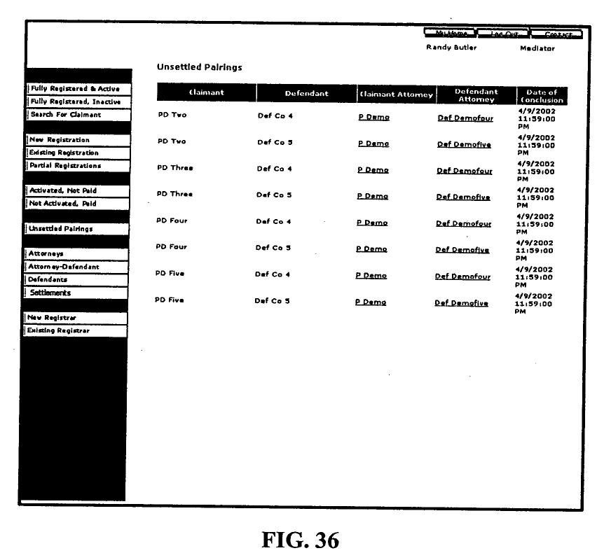

FIG. 36 is a representation of a computer display showing a list of unsettled pairings. This screen displays mediations for unsettled pairings. This report identifies cases that did not settle online. The Mediator may contact the attorneys involved and attempt to facilitate further settlement efforts. The Mediator can also extend the end date of the mediation pairing, thus reactivating the online mediation and making it possible for the parties to exchange additional offers and demands, as well as additional information through the Notes and/or pre-set field on General Exchange and Private Exchange.

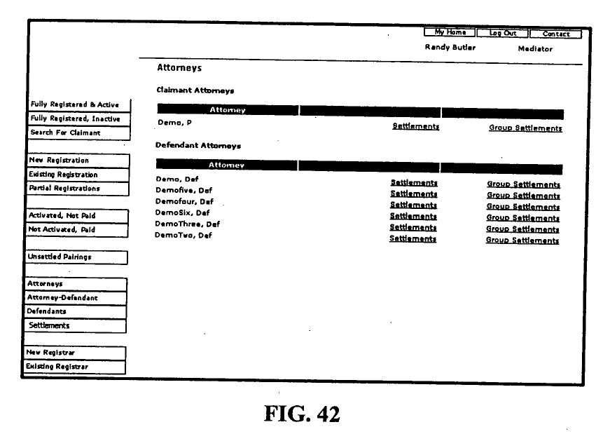

FIG. 42 is a representation of a computer display depicting a screen utilized to obtain reports of all settlements for a particular user.

FIG. 46 is a representation of a computer display showing Concluded Mediations for a Defendant. Various information is shown for concluded meditations. For concluded mediations, the system will automatically generate settlement documents and send them to the particular disputant's attorney. The document preferably is sent to the attorneys via e-mail, but may be sent via other methods. Also, the settlement document may be reviewed using the system by selecting “Click to View” under the column “Auto-Documentation”. Preferably, when a particular settlement is achieved a settlement document will be created using the party information from the settlement. For example, the party names and their attorneys names will be populated in the signature block. The system selects the appropriate settlement document based on the particular court where the dispute was initiated. This allows the system to utilize various forms of settlement document for different jurisdictions and courts. The parties may then each execute the settlement document. Any document utilized for settlement purposes may be used.

In addition to the available form documents in the system, the disputant's attorneys may submit a particular settlement document that they want to use. This tailored settlement document is then added to the system and is made only available to the attorneys in the particular dispute. This function provides custom tailoring of settlement documents for the particular dispute. Similar to the above discussion, fields are added to the custom document such that those fields are automatically populated with germane information relating to the disputants that settle.

Searching for Information

The inventive system provides screens usable by the disputant representatives, the Mediator, authorized Registrar, to search on various data. Although the data stored in the database may be searched with appropriate permissions and security, screens discussed in this section are particularly useful. The data fields used for searching for particular data may be any of those fields on the database that would assist a particular user in searching for particular data. Additionally, the search criteria fields may be set up in the conjunctive and disjunctive, using wild card characters and in combination with one another.

FIG. 1 is a representation of a computer display depicting a screen for searching existing registrations. To find an existing registration on the system, the Registrar clicks on the “Existing Registration” tab on the left of the screen. In response, the system displays a registration search screen as depicted in FIG. 1. This registration search function is not available to the disputants or the disputant representatives. Entry of information in any one of the input boxes and clicking on “Search” button causes the system to search for registrations based on the criteria selected.

FIG. 1A is a representation of a computer display showing exemplary search results for registrations. Registration records meeting the criteria of the search request of the screen of FIG. 1 are presented to the Registrar. The Registrar may click on any of search request resulting records. The system will then display the “Registration Summary” screen (FIG. 1B) for the particular record selected.

FIGS. 1B is a representation of computer display depicting registration summary information. In one embodiment, this “Registration Summary” screen display three sections of information: (1) claim information, including cause no., court and county, (2) general information showing the claimants, defendants and their attorneys, and (3) pairing information. By clicking on an “Edit” button for the respective section, the systems allows the Registrar to change information, enter new mediation start and end dates, and activate or deactivate a mediation pairing. If a mediation pairing is deactivated, it becomes “view only” and no information can be entered and no offers and demands made.

FIG. 7 is a representation of a computer display showing a list of exemplary Full registrations. In response to a request by the Registrar, the system displays a listing of recent registrations.

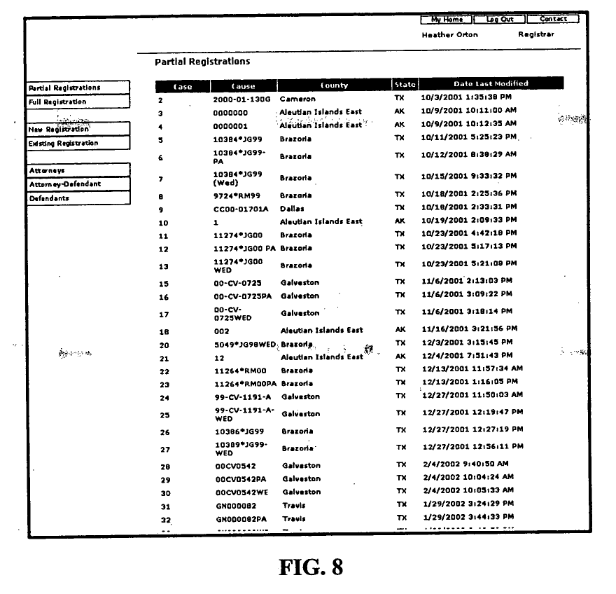

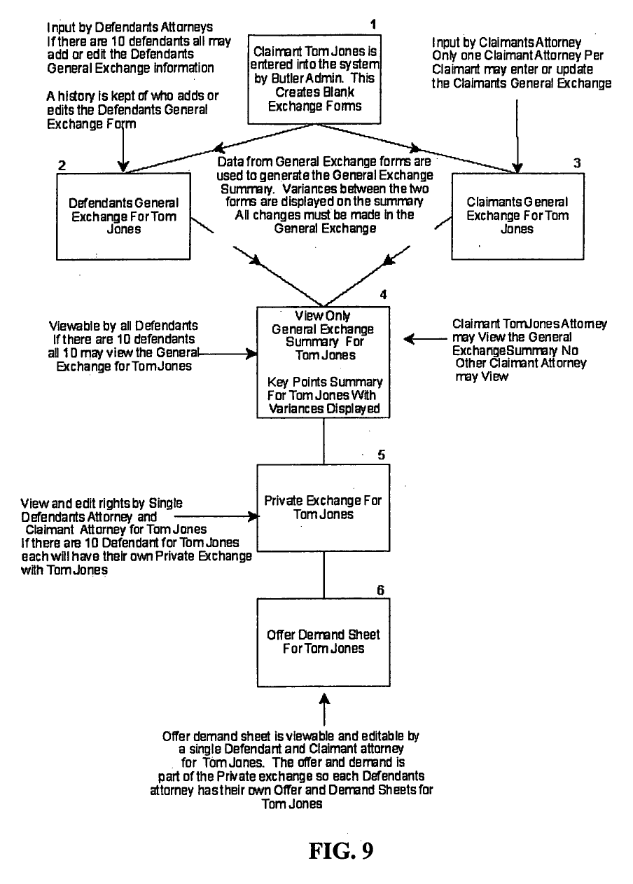

FIG. 8 is a representation of a computer display showing a list of partial registrations. In response to a request by the Registrar, the system displays a listing of recent partial registrations. This means that the Registrar began registration of a particular dispute or case, but did not complete the registration. In one embodiment, this report is set as the default home screen for the Registrar to prompt the Registrar that certain registrations have not been completed.

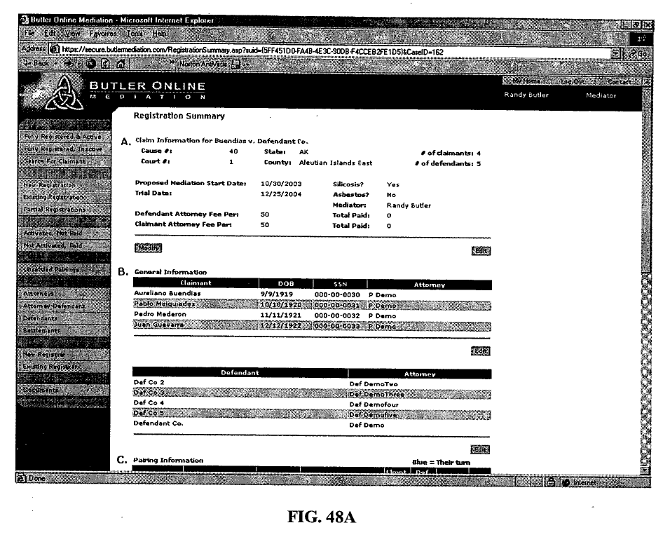

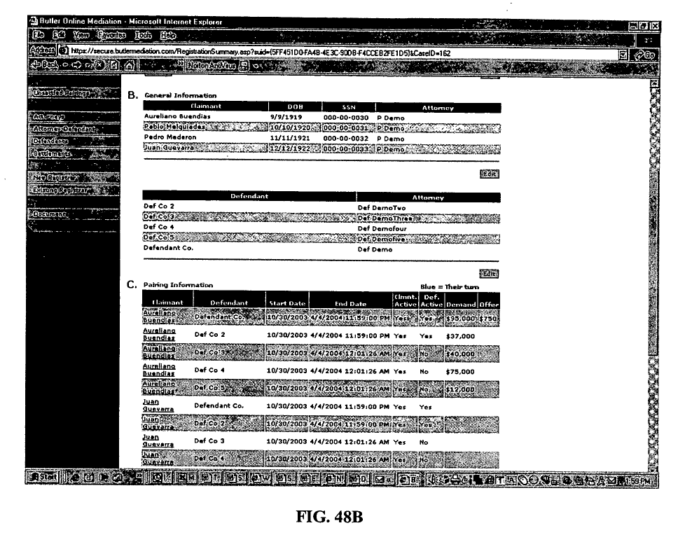

Now referring to FIGS. 48A-B, representations are depicted of computer displays showing Registration Summary. The registration summary screen allows the mediator to easily track last offers and demands by any party to a given case. The screen facilitates easy access by the mediator to edit or modify particular information by selecting the “Edit” button for a particular information. The displayed information is not limited to what is displayed in FIGS. 48A-B, but may include other information that would assist the mediator in reviewing a particular registration.

Various information is shown on the registration summary which is separated into three sections A, B, and C. Section A includes summary information for a particular dispute. For example, in one embodiment the following information is shown: the Cause Number of a case, the Court Number of the Case, and State and County where the case was filed, and the number of the claimants and defendants. Section B includes general information about the particular registration. For example, information about the claimants and defendants may be shown, such as Claimant Name, Date of Birth, Social Security Number, and their Attorney. With respect to the Defendant, their name and attorney may be shown. In Section C, Pairing Information is shown. The pairing information includes Claimant name, the Defendant Name, the Start Date, the End Date, whether the Claimant is Active, or if the Defendant is Active, and the respective Claimant and Defendant's Last Demand and Offer. The registration summary also highlights information about a particular party to signify whose turn it is to make the next Demand or Offer. This provides readily discernable visual cue for the mediator. With respect to the column showing whether the Claimant or Defendant is active, this allows the mediator address those disputants that have not yet become active in the system.

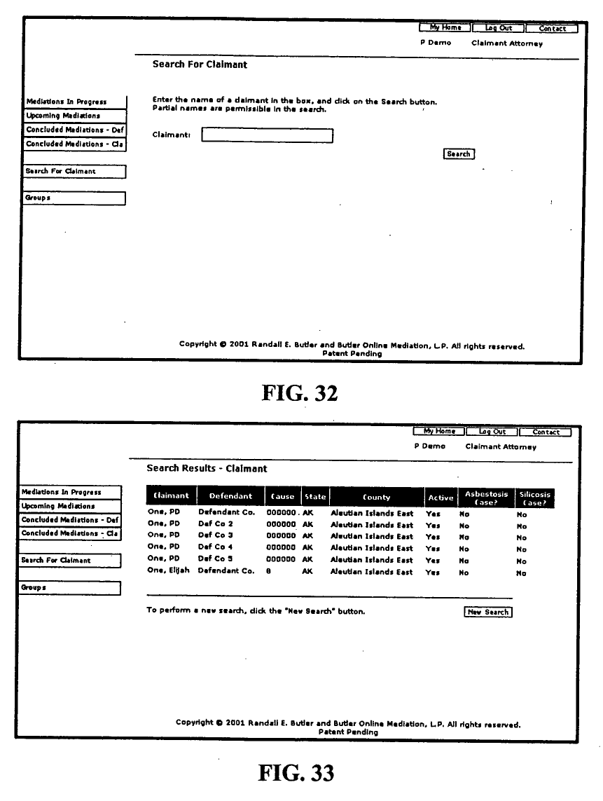

FIG. 32 is a representation of a computer display depicting a screen for searching existing claimants. If an attorney is unable to find a particular pairing on his Upcoming Mediations, Mediations in Progress, or Concluded Mediations screens, then he can search for the pairing. He clicks on the tab to the left titled Search for Claimant and he is taken to the Search for Claimant screen. If he enters the name of a claimant he will be taken to the Search Results-Claimant screen (see FIG. 33).

FIG. 33 is a representation of a computer display showing exemplary search results for claimants. Clicking on the claimant's name will take the attorney to the general exchange for that claimant/attorney pairing (see FIG. 11).

Notifying Disputant Representatives of Events

The inventive system and method may provide notification of events to disputant representatives. Various events occur which may trigger a notification to a disputant representative. This notification may be e-mail, facsimile, automated telephonic call, systematically generated mail to be sent by regular mail or private carrier, or a display on a screen indicating that a particular event has occurred. Furthermore, the notification may be by one or more of the identified notification means. The following list exemplifies the types of events that may trigger automatic notification:

1. To the claimant's attorney and all defendants attorneys representing defendants in a particular dispute when that dispute is first registered by the claimant's attorney or one of the defendant attorneys.

2. To the claimant's attorney if the defendant attorney makes an offer to the claimant represented by that claimant's attorney.

3. To the defendant attorney for the defendant to whom the claimant's attorney makes a demand.

4. To the claimant attorney and the defendant attorney for the defendant with whom the claimant has concluded a settlement as determined by the party who accepts the offer or demand on the offer/demand sheet.

5. To a judge or magistrate indicating that settlement has been reach or settlement has been reached but not finalized between the disputing parties.

Note Making Function

Referring now to FIG. 38 is a representation of a computer display depicting the notes making function in the direct negotiation of single pairings. The Notes making function allows a user to communicate information that is not otherwise communicable using the preset fields in the second section of the Private Exchange. Each disputant representative can make specific notes to the opposing disputant representative with each offer and demand. The user types in his message in the field provided. See FIG. 38. He then clicks on submit. The Note is saved to the database and is recorded in the “History of Demands and Offers,” where it can be read by the mediator, the opposing disputant representative, and the disputant representative submitting the Note.

Further, FIG. 18 is a representation of a computer display depicting the notes as they appear on the History of Demands and Offers, including a private note by the defendant's representative. If the disputant representative types the note in the field provided and then clicks the box next to “Hide from [Claimant/Defendant] attorney,” the Note will be recorded only in the “History of Demands and Offers” in the views of the mediator and the disputant representative making the Note.

Now turning to FIG. 10, a representation of a computer display is shown depicting the Mediations in Progress Screen bearing the notations of Notes. When a note is recorded by a disputant representative in a Private Exchange, the notation “Notes” appears on the line for that pairing on the Mediations in Progress screen. If the Note was made by the Plaintiff's attorney in connection with a demand, the notation: “Notes” appears in the Last Demand Column. If the Note was made by the Defendant's Attorney, the notation appears in the column under Last Offer. Either lawyer to the exchange can click on the notation on the Mediations in Progress screen to access the Private Exchange in order to read the note.

The Notes notation disappears from the Mediations in Progress Screen once a new offer is made after in intervening demand since the note made with the prior offer. In other words, the notation notes appears only immediately after the Note has been made and stays on the Mediations in Progress screen only until another offer is made without a note.

Notes can also be made in connection with Group Offers and Demands. FIG. 23 depicts the Group Offer Demand Screen and includes the field in which notes may be written and submitted.

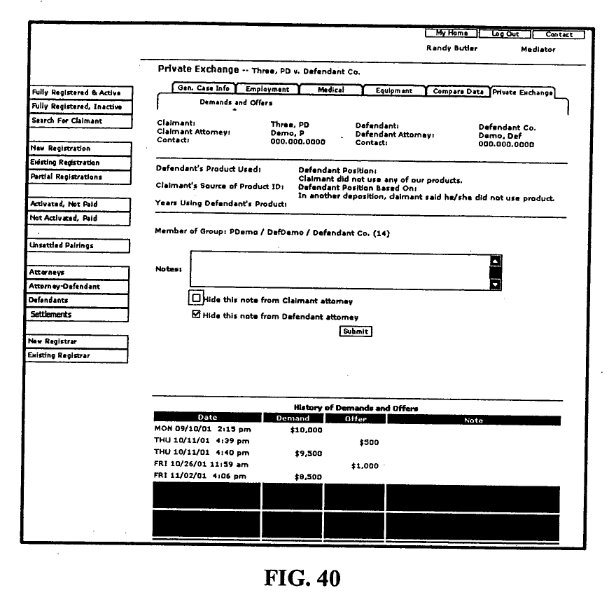

Referring now to FIG. 40 a representation of a computer display is shown of the mediator's screen of the private exchange and depicts his ability to make Mediator Notes. This figure demonstrates the ability of the Mediator to record a note viewable by one of the attorney users but not the other, thus making it possible for the Mediator to communicate with the attorney confidentially. The Mediator can also submit Notes to be read by one or the other of the attorneys (or both) with access rights to the particular mediation pairing. This provides the mediator the opportunity to communicate directly with any attorney user he chooses as part of an online mediation. The Mediator Notes are recorded in the “History of Demands and Offers” on the Private Exchange of the particular mediation pairing in which the Mediator Notes were made. The Mediator Notes function provides an opportunity for the mediator to interact with the attorneys for the parties at the point that he chooses to intervene in the making of offers and demands. Through the Notes function, the mediator is able to fulfill one of the primary functions of a mediator—facilitating the discussion of the case and the negotiation process. The Mediator Note is recorded in the chronological order that it was made, after the last offer or demand made before submission of the note and before the next offer or demand. When the Mediator makes a note on a case, the notation: “Notes” shows up on the Mediations in Progress Screen for the side that the note is not hidden from.

Non-suit Request Function

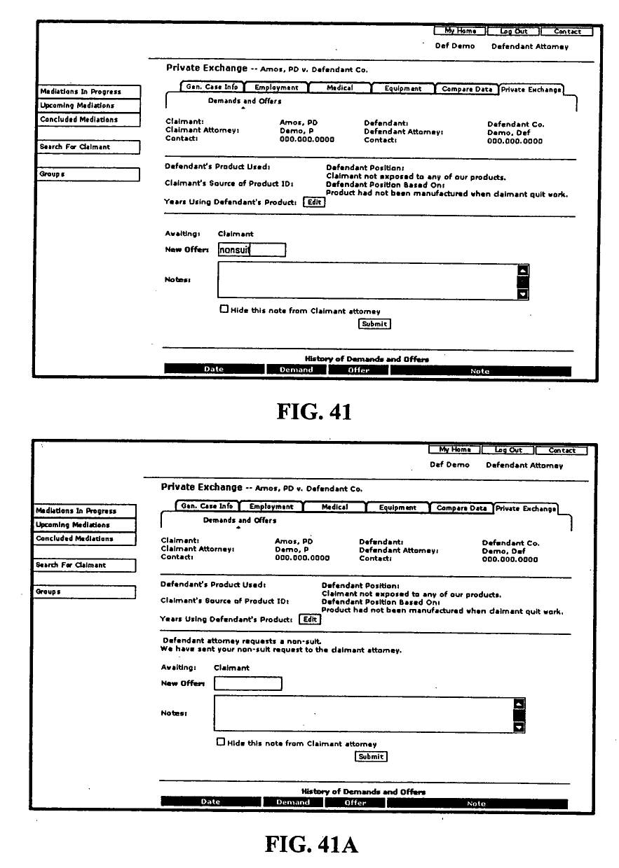

Referring now to FIGS. 41 and 41A representations of computer displays are shown for submitting a non-suit request. This non-suit functionality provides the ability for a defendant to submit a Non-Suit Request as opposed to a monetary offer or demand. The user. types in the word “nonsuit” in the space in which a monetary offer would be typed. The plaintiff's attorney can agree to the non-suit request by typing in “nonsuit” in the same space on his Private Exchange page. The case will then be shown as non-suited. FIG. 41A shows the non-suit request after it has been submitted as it will appear on the Private Exchange screen. Non-suit requests are also then shown on the Mediations in Progress screen for both parties. The attorney for a defendant can submit a request that a particular plaintiff agree to non-suit his client. He can do so by typing in the word non-suit in the box on the private exchange where he would normally type in a numeric offer. When he submits the non-suit request, it is recorded in red on the Private Exchange screen for that particular mediation pairing of both the Plaintiff's Attorney and the Defendant's Attorney. The notation Non-suit Request is also recorded on the Mediations in Progress Screen on the line for that pairing.

By clicking on the Non-suit Request notation, the Plaintiff's Attorney will be taking to the Private Exchange for that pairing where he can read any explanation for the basis for the Non-suit. He can agree to the Non-suit simply by typing in “non-suit” in the box for submitting a demand. Once he does so, the system records a Non-suit as the final resolution of the pairing.

The inventive systems and methods described above are well adapted for the resolution of disputes over an interactive computer network, and thus the description focuses on this application of the invention. However, it shall be noted that the foregoing description is presented for purposes of illustration and description, and is not intended to limit the invention to the form disclosed herein. Consequently, variations and modifications to the systems and processes commensurate with the above teachings and teaching of the relevant art are within the scope of the invention. For example, as mentioned previously, several aspects of the invention may be adapted for application or implementation onto an interactive computer network or client-server system other than the Internet. These variations will readily suggest themselves to those skilled in the relevant art and are encompassed within the spirit of the invention and the scope of the following claims.

Moreover, the embodiments described are further intended to explain the best modes for practicing the invention, and to enable others skilled in the art to utilize the invention in such, or other, embodiments and with various modifications required by the particular applications or uses of the present invention. It is intended that the appending claims be construed to included alternative embodiments to the extent that it is permitted by the prior art.

What is claimed is:

1. A computer-implemented method of on-line dispute resolution for a dispute, said method comprising:
(a) receiving a settlement offer from a first party; and
(b) presenting said settlement offer from said first party to a second party;
(c) receiving a settlement counter-offer from said second party;
(d) presenting said settlement counter-offer to said first party; and
(e) repeating steps (a)-(d) until the dispute it settled.

2. The computer-implemented method of claim 1, wherein the first party comprises one or more claimants and the second party comprises one or more defendants.

3. The computer-implemented method of claim 1, wherein the first party comprises one or more defendants and the second party comprises one or more claimants.

4. The computer-implemented method of claim 1, wherein the settlement offer comprises one or more settlement offers.

5. The computer-implemented method of claim 1, wherein the settlement counter-offer comprises one or more counter-offers.

6. The computer-implemented method of claim 1, wherein step (a) and step (c) is limited to a time duration after which no further offers or counter-offers may be received.

7. The computer-implemented method of claim 1, wherein the settlement offer is associated with a group negotiation number.

8. The computer-implemented method of claim 1, further comprising the step of:
generating a report for presentation to said first party, said report summarizing the settlement offers made by second party.

9. The computer-implemented method of claim 1, further comprising the step of:
generating a report for presentation to said second party, said report summarizing the settlement offers made by the first party.

10. The computer-implemented method of claim 1, wherein the first party is a group of one or more claimants, and the offer is an aggregate group offer from the claimants;
the second party is a group of one or more defendants and the counter-offer is made as individual offers from each of the defendants.

11. The computer-implemented method of claim 1, wherein the first party is a group of one or more defendants, and the offer is an aggregate group offer from the defendants;
the second party is a group of one or more claimants and the counter-offer is made as individual offers from each of the claimants.

12. The computer-implemented method of claim 10 or claim 11, further comprising settling the dispute for the claimants and defendants when the sum of the individual demands is equal to or greater than the aggregate group offer.

13. The computer-implemented method of claim 1, further comprising:
generating one or settlement documents when the dispute it settled.

14. The computer-implemented method of claim 1, further comprising:
receiving a dispute registration for said dispute; and
storing said dispute registration into a database with a unique dispute identifier.

15. The computer-implemented method of claim 14, further comprising:
providing to said first and second party each a unique access identifier, said unique access identifier associated to said dispute identifier.

16. The computer-implemented method of claim 1, further comprising:
displaying a set of questions related to said dispute to said first party;
receiving a first set of general exchange information from said first party;
displaying to a second party, said set of questions related to said dispute; and
receiving a second set of general exchange information from said second party.

17. The computer-implemented method of claim 16, further comprising the step of:
presenting a comparison of said first and second sets of general exchange information, said comparison identifying matching and non-matching general exchange information.

18. The computer-implemented method of claim 16, further comprising the step of:
receiving a first set of private exchange information from said first party; and
receiving a second set of private exchange information for said second party;
wherein the first set of private exchange information is not viewable by the second party; and the second set of private exchange information is not viewable by the first party.

19. The computer-implemented method of claim 16, wherein said questions are determined for presentation based on a dispute type.

20. The computer-implemented method of claim 1, wherein the settlement offer or the settlement counter-offer is a non-suit request.

21. A computer-usable medium having computer-readable program code embodied therein for causing a computer to perform the steps of:
(a) receiving a settlement offer from a first party; and
(b) presenting said settlement offer from said first party to a second party;
(c) receiving a settlement counter-offer from said second party;
(d) presenting said settlement counter-offer to said first party; and
(e) repeating steps (a)-(d) until the dispute it settled.

22. The computer-usable medium of claim 21, wherein, wherein the first party comprises one or more claimants and the second party comprises one or more defendants.

23. The computer-usable medium of claim 21, wherein the first party comprises one or more defendants and the second party comprises one or more claimants.

24. The computer-usable medium of claim 21, wherein the settlement offer comprises one or more settlement offers.

25. The computer-usable medium of claim 21, wherein the settlement counter-offer comprises one or more counter-offers.

26. The computer-usable medium of claim 21, wherein step (a) and step (c) is limited to a time duration after which no further offers or counter-offers may be received.

27. The computer-usable medium of claim 21, wherein the settlement offer is associated with a group negotiation number.

28. The computer-usable medium of claim 21, wherein said computer-readable program code embodied therein causes a computer to further perform the step of:
generating a report for presentation to said first party, said report summarizing the settlement offers made by second party.

29. The computer-usable medium of claim 21, wherein said computer-readable program code embodied therein causes a computer to further perform the step of:
generating a report for presentation to said second party, said report summarizing the settlement offers made by the first party.

30. The computer-usable medium of claim 21, wherein said computer-readable program code embodied therein causes a computer to further perform the step of:
notifying the first party and the second party of the mean value.

31. The computer-usable medium of claim 21, wherein the first party is a group of one or more claimants, and the offer is an aggregate group offer from the claimants;
the second party is a group of one or more defendants and the counter-offer is made as individual offers from each of the defendants.

32. The computer-usable medium of claim 21, wherein the first party is a group of one or more defendants, and the offer is an aggregate group offer from the defendants;
the second party is a group of one or more claimants and the counter-offer is made as individual offers from each of the claimants.

33. The computer-usable medium of claim 31 or claim 32, wherein said computer-readable program code embodied therein causes a computer to further perform the step of:
settling the dispute for the claimants and defendants when the sum of the individual demands is equal to or greater than the aggregate group offer.

34. The computer-usable medium of claim 21, wherein said computer-readable program code embodied therein causes a computer to further perform the step of:
generating one or settlement documents when the dispute it settled.

35. The computer-usable medium of claim 21, wherein said computer-readable program code embodied therein causes a computer to further perform the step of:
receiving a dispute registration for said dispute; and
storing said dispute registration into a database with a unique dispute identifier.

36. The computer-usable medium of claim 35, wherein said computer-readable program code embodied therein causes a computer to further perform the step of:
providing to said first and second party each a unique access identifier, said unique access identifier associated to said dispute identifier.

37. The computer-usable medium of claim 21, wherein said computer-readable program code embodied therein causes a computer to further perform the step of:
displaying a set of questions related to said dispute to said first party;
receiving a first set of general exchange information from said first party;
displaying to a second party, said set of questions related to said dispute; and
receiving a second set of general exchange information from said second party.

38. The computer-usable medium of claim 37, wherein said computer-readable program code embodied therein causes a computer to further perform the step of:
presenting a comparison of said first and second sets of general exchange information, said comparison identifying matching and non-matching general exchange information.

39. The computer-usable medium of claim 37, wherein said computer-readable program code embodied therein causes a computer to further perform the steps of:
receiving a first set of private exchange information from said first party; and
receiving a second set of private exchange information for said second party;
wherein the first set of private exchange information is not viewable by the second party; and the second set of private exchange information is not viewable by the first party.

40. The computer-usable medium of claim 37, wherein said questions are determined for presentation based on a dispute type.

41. The computer-usable medium of claim 37, wherein the settlement offer or the settlement counter-offer is a non-suit request.
